(19) United States
(12) Patent Application Publication
(10) Pub. No.: US 2024/0068604 A1
(43) Pub. Date: Feb. 29, 2024

(54) ADDITIVELY MANUFACTURED BELLOWS

(71) Applicant: Relativity Space, Inc., Long Beach, CA (US)

(72) Inventors: Daniel CHRISTIANSEN, Long Beach, CA (US); Lewis JONES, Long Beach, CA (US); Anthony WIMER, Long Beach, CA (US); Filip JANDER, Long Beach, CA (US)

(73) Assignee: Relativity Space, Inc., Long Beach, CA (US)

(21) Appl. No.: 18/160,786

(22) Filed: Jan. 27, 2023

Related U.S. Application Data
(60) Provisional application No. 63/373,961, filed on Aug. 30, 2022.

(51) Int. Cl. F16L 11/15

(52) U.S. Cl. CPC F16L 11/15; F02K 9/97

(57) ABSTRACT

A bellows assembly includes a first compliant portion extending outwardly at a first angle relative to a lateral axis, a second compliant portion, and a third compliant portion extending outwardly at a second angle relative to the lateral axis. The second compliant portion is formed between, and coupled to, the first and third compliant portions. The first angle and the second angle are between about 30 degrees to 80 degrees, such that the first compliant portion and the third compliant portion form inward extending cone shapes.

### CROSS REFERENCE TO RELATED APPLICATIONS

This application claims the benefit of U.S. provisional application No. 63/373,691 filed Aug. 30, 2022, the contents of which is hereby incorporated by reference in its entirety.

### BACKGROUND

### Technical Field

The present disclosure relates to bellows. More specifically, embodiments of the present disclosure relate to bellows geometry and methods of manufacturing bellows geometry.

### Background

Expansion joints and bellows are used to create structural compliance and potential energy storage in fluid and mechanical systems. An expansion joint is any device containing one or more bellows used to absorb dimensional changes. A bellows is a flexible element of an expansion joint with one or more convolutions. Bellows compliance can reduce stress in mechanical systems or store energy in piston driven systems such as hydraulic actuators or similar moving mechanical assemblies. In addition, bellows are used in various applications to provide compliance and movement between rigid leak-tight ducts or lines that are used to transfer gases or liquids.

### SUMMARY

The present disclosure can comprise one or more of the following features and combinations thereof. The descriptions herein represent non-limiting invention embodiments.

According to an embodiment of the present disclosure, a bellows assembly can include a first connecting portion, a second connecting portion, and at least one convolution portion. In some embodiments, the first connecting portion is configured to connect to a first component. In some embodiments, the second connecting portion configured to connect to a second component. In some embodiments, the at least one convolution portion extends between the first connecting portion and the second connecting portion and is configured to provide compliance such that the first connecting portion moves relative to the second connecting portion.

In some embodiments, the at least one convolution portion includes a first end, a second end, a longitudinal axis, a first compliant portion, a second compliant portion, and a third compliant portion. In some embodiments, the first end is located toward the first connecting portion. In some embodiments, the second end is spaced apart from the first end, toward the second connecting portion. In some embodiments, the longitudinal axis extends from the first end to the second end and a lateral axis is perpendicular to the longitudinal axis. In some embodiments, the first compliant portion extends outwardly away from the first end at a first angle relative to the lateral axis. In some embodiments, the third compliant portion extends outwardly away from the second end at a second angle relative to the lateral axis, and the second compliant portion is formed between and coupling to distal ends of the first and third compliant portions. In some embodiments, the first angle and the second angle are between about 30 degrees to 80 degrees such that the first compliant portion and the second compliant portion form inward extending cone shapes.

In some embodiments, the first angle and the second angle are equal such that the first compliant portion is parallel to the second compliant portion. In some embodiments, the first angle is different from the second angle such that the first compliant portion and the second compliant portion converge toward the first end and the second end.

In some embodiments, a starter portion extends away from the second compliant portion along the longitudinal axis and is configured to provide a starting point for additively manufacturing the at least one convolution portion. In some embodiments, the first connecting portion is integrally formed with the first component and the second connecting portion is integrally formed with the second component, such that the first component, the first connecting portion, the second connecting portion, and the second component are a single piece structure. A single piece structure means that the structure is a single piece of material and is not multiple pieces of material joined by one or more weld joints, solder joints, or the like. A conventionally manufactured bellows is a multi-piece structure and is not a single piece structure under this definition. By contrast, an additively manufactured structure, formed from deposition of layers of a material, is a single piece structure under this definition.

In some embodiments, the first connecting portion and the second connecting portion move relative to one another in at least one of an axial movement perpendicular to the longitudinal axis, compression or extension along the longitudinal axis, and a gimballing tilting angle relative to the longitudinal axis.

In some embodiments, the at least one convolution portion comprises at least four convolution portions. In some embodiments, the second compliant portion is located below the first end and the second end. In some embodiments, the at least one convolution portion has a wall thickness of about 0.5 millimeters.

According to another embodiment of the present disclosure, a bellows assembly includes a first connecting portion, a second connecting portion, and at least one convolution portion formed between the first connecting portion and the second connecting portion and configured to provide compliance such that the first connecting portion moves relative to the second connecting portion. In some embodiments the at least one convolution includes a first end, a second end, a longitudinal axis extending from the first end to the second end, a lateral axis perpendicular to the longitudinal axis, a first compliant portion, a first tube portion, a second tube portion, a second compliant portion, a third tube portion, and a third compliant portion. In some embodiments, the first compliant portion extends outwardly away from the first end at a first angle relative to the lateral axis. In some embodiments, the first tube portion extends away from the first compliant portion end. In some embodiments, the second tube portion is radially spaced apart from the first tube portion. In some embodiments, the second compliant portion is formed between and couples the first and second tube portions. In some embodiments, the third tube portion is radially spaced apart from the second tube portion and extends away from the second end approximately parallel to the longitudinal axis. In some embodiments, the third compliant portion is formed between and couples the second and third tube portions.

In some embodiments, the first angle is between about 30 degrees to 80 degrees such that the first compliant portion forms inward extending cone. In some embodiments, at least two of the first, second, and third tube portions are axially aligned along the longitudinal axis. In some embodiments, the first tube portion and the second tube portion are radially spaced apart by a first distance, and the second tube portion and the third tube portion are radially spaced apart by a second distance, and the first distance is equal to the second distance.

In some embodiments, the at least one convolution portion is at least four convolution portions. In some embodiments, the at least one convolution portion has a wall thickness of about 0.5 millimeters. In some embodiments, the at least one convolution further includes a fourth tube portion, a fourth compliant portion, a fifth tube portion, and a fifth compliant portion. In some embodiments, the fourth tube portion is radially spaced apart from the third tube portion. In some embodiments, the fourth compliant portion is formed between and couples the fourth tube portion to the second end and third tube portion. In some embodiments, the fifth tube portion is radially spaced apart from the fourth tube portion and extends away from a third end. In some embodiments, the fifth compliant portion is formed between and couples the fourth and fifth tube portions.

According to another embodiment of the present disclosure, a bellows includes a first connecting portion at a first end of the bellows, a second connecting portion at a second end of the bellows opposite the first end along a longitudinal axis of the bellows, and a plurality of convolutions located between the first connecting portion and the second connection portion. The plurality of convolutions include compliant portions having an angled shape and compliant portions having a substantially arcuate shape. The compliant portions having the substantially arcuate shape connect the compliant portions having the angled shape.

In some embodiments, the angled shape is an inward extending cone shape. In some embodiments, the compliant portions having the angled shape may be first compliant portions extending outwardly at a first angle relative to a lateral axis of the bellows. The first angle may be between about 10 degrees to 90 degrees. In some embodiments, the first angle is between about 15 degrees to 45 degrees. In some embodiments, the compliant portions having a substantially arcuate shape may be second compliant portions. In some embodiments, the second compliant portions may have a fillet radius of about 0.5 mm. In some embodiments, the compliant portions having the angled shape may be third compliant portions extending outwardly at a second angle relative to the lateral axis of the bellows. The second angle may be between about 30 degrees to 45 degrees. In some embodiments, the first compliant portions form inward extending cone shapes. In some embodiments, the substantially arcuate shape include a smooth radius. The substantially arcuate shape may include a compound radii curve.

In another embodiment of the present disclosure, a bellows includes a first connecting portion at a first end of the bellows, a second connecting portion at a second end of the bellows opposite the first end along a longitudinal axis of the bellows, and a plurality of convolutions located between the first connecting portion and the second connection portion. The plurality of convolutions include compliant portions extending outwardly at a first angle between 15 degrees to 45 degrees relative to a lateral axis of the bellows, and compliant portions extending outwardly at a second angle between 30 degrees to 45 degrees relative to the lateral axis of the bellows. In some embodiments, the first angle is substantially narrower than the second angle. In some embodiments, the first angle and the second angle are substantially equal.

According to another embodiment of the present disclosure, a bellows assembly includes a first connecting portion, a second connecting portion, and a helix convolution portion formed between the first connecting portion and the second connecting portion and configured to provide compliance such that the first connecting portion moves relative to the second connecting portion. In some embodiments, the second connecting portion is spaced apart from the first connecting portion along a longitudinal axis. In some embodiments, the helix convolution portion extends circumferentially around and along the longitudinal axis and has a first section with a first angle relative to a lateral axis that is perpendicular to the longitudinal axis.

In some embodiments, the helix convolution comprises a second section extending from the first section. In some embodiments, the second section has a second angle relative to the lateral axis, wherein the second angle is greater than the first angle. In some embodiments, the first section has a first height along the longitudinal axis, the second section has a second height along the longitudinal axis, and the first height is greater than the second height. In some embodiments, the first angle is between about 10 degrees and about 30 degrees, and the second angle is between about 30 degrees and about 60 degrees.

In some embodiments, the at least one convolution portion connects a first component to a second component. In some embodiments, the at least one convolution is configured to provide at least one of longitudinal, lateral, or angular compliance between the first component and the second component. In some embodiments, the first compliant portion extends outwardly away from a first end at a first angle of about 30 degrees relative to a lateral axis of the bellows assembly. In some embodiments, the bellows assembly further includes a starter portion that extends away from a second compliant portion along a longitudinal axis. In some embodiments, the starter portion is configured to provide a starting point for additively manufacturing the at least one convolution portion.

Further features and advantages, as well as the structure and operation of various embodiments, are described in detail below with reference to the accompanying drawings. It is noted that the specific embodiments described herein are not intended to be limiting. Such embodiments are presented herein for illustrative purposes only. Additional embodiments will be apparent to persons skilled in the relevant art based on the teachings contained herein.

### BRIEF DESCRIPTION OF THE DRAWINGS

The accompanying drawings, which are incorporated herein and form a part of the specification, illustrate embodiments of the present disclosure and, together with the description, further explain the principles of the disclosure and to enable a person skilled in the pertinent art to make and use the disclosure.

FIG. 1 illustrates a block diagram of an example rocket engine showing various locations where bellows can be located.

FIG. 2 illustrates a side view of a conventional known bellows design made by conventional methods.

FIG. 3 illustrates a cross-sectional side view of a first bellows configuration, according to an embodiment of the present disclosure.

FIG. 4 illustrates a cross-sectional side view of the first bellows configuration with alternate geometry features for printability and stiffness, according to an embodiment of the present disclosure.

FIG. 5 illustrates a detailed view of the convolution shown in FIG. 4, according to an embodiment of the present disclosure.

FIG. 6 illustrates a cross-sectional side view of a second bellows configuration, according to an embodiment of the present disclosure.

FIG. 7 illustrates a cross-sectional side view of the second bellows configuration with alternate geometry features for printability and stiffness, according to an embodiment of the present disclosure.

FIG. 8 illustrates a detailed view of the convolution shown in FIG. 7, according to an embodiment of the present disclosure.

FIG. 9 illustrates a cross-sectional side view of the first bellows configuration showing manufacturing features to support the bellows, according to an embodiment of the present disclosure.

FIG. 10 illustrates a cross-sectional side view of a third bellows configuration, according to an embodiment of the present disclosure.

FIG. 11 illustrates a cross-sectional side view of a fourth bellows configuration, according to an embodiment of the present disclosure.

FIG. 12 illustrates a cross-sectional side view of a fifth bellows configuration, according to an embodiment of the present disclosure.

FIG. 13 illustrates a perspective view of the fifth bellows configuration with a steeper helix angle of the plurality of helixes, according to an embodiment of the present disclosure.

FIG. 14 illustrates a perspective view of a sixth bellows configuration showing a helix convolution, according to an embodiment of the present disclosure.

FIG. 15 illustrates a top perspective view of the sixth bellows configuration of FIG. 14, according to an embodiment of the present disclosure.

FIG. 16 illustrates a graphical view of an example geometry of the sixth bellows configuration of FIG. 14, according to an embodiment of the present disclosure.

FIG. 17 illustrates a perspective view of a seventh bellows configuration, according to an embodiment of the present disclosure.

FIG. 18 illustrates a side view of an eighth bellows configuration, according to an embodiment of the present disclosure.

FIG. 19 illustrates a detailed view of the starting portion shown in FIG. 18, according to an embodiment of the present disclosure.

FIG. 20 illustrates a cross-section detailed view of the convolution shown in FIG. 18, according to an embodiment of the present disclosure.

FIG. 21 illustrates a bellows assembly, such as the bellows assembly shown in FIG. 18, coupled to an adjacent component of an engine, such as a rocket engine, according to an embodiment of the present disclosure.

FIG. 22 illustrates a cross-sectional top view of a ninth bellows configuration, according to an embodiment of the present disclosure.

FIG. 23 illustrates a cross-sectional side view of the convolution of the ninth bellows configuration, according to an embodiment of the present disclosure.

FIG. 24 illustrates a cross-section perspective view of the ninth bellows configuration, according to an embodiment of the present disclosure.

FIG. 25 illustrates a perspective view of a tenth bellows configuration, according to an embodiment of the present disclosure.

FIG. 26 illustrates a cross-sectional top view of the tenth bellows configuration, according to an embodiment of the present disclosure.

FIG. 27 illustrates a cross-sectional side view of the tenth bellows configuration, according to an embodiment of the present disclosure.

FIG. 28 illustrates a perspective view of an eleventh bellows configuration, according to an embodiment of the present disclosure.

FIG. 29 illustrates a cross-section side view of the eleventh bellows configuration, according to an embodiment of the present disclosure.

FIG. 30 illustrates a first cross-sectional top view of the eleventh bellows, according to an embodiment of the present disclosure.

FIG. 31 illustrates a detailed perspective view of a cap portion of the eleventh bellows configuration, according to an embodiment of the present disclosure.

FIG. 32 illustrates a perspective view of a twelfth bellows configuration, according to an embodiment of the present disclosure.

FIG. 33 illustrates a cross-sectional side view of the twelfth bellows configuration, according to an embodiment of the present disclosure.

FIG. 34 illustrates a detailed cross-sectional view of the convolution of the twelfth bellows configuration, according to an embodiment of the present disclosure.

FIG. 35 illustrates a cross-sectional top view of the twelfth bellows configuration, according to an embodiment of the present disclosure.

FIG. 36 illustrates a thirteenth bellows configuration, according to an embodiment of the present disclosure.

### DETAILED DESCRIPTION

Standards for expansion joint design, testing, and production make traditional methods for manufacturing bellows low risk and the logical choice of aerospace companies and similarly risk adverse industries. The inventors realized and discovered that traditional manufacturing methods cause long lead times for delivering bellows components due to expensive and complicated tooling. They further realized and discovered that traditional tooling cannot be easily changed or adapted to modify bellows geometry, making quick design modifications of the bellows for particular applications difficult. The present disclosure describes inventive bellows geometries and methods of manufacturing bellows geometries that can leverage additive manufacturing to solve these and other problems that the inventors discovered and overcame. Embodiments of the present disclosure will be described with reference to the accompanying drawings.

In some embodiments of the present disclosure, the terms “about” and “substantially” can indicate a value of a given quantity that varies within 20% of the value (e.g., +1%, +2%, +3%, +4%, +5%, +10%, +20% of the value). These values are merely examples and are not intended to be limiting. The terms “about” and “substantially” can refer to a percentage of the values as interpreted by those skilled in relevant art in light of the teachings herein.

Further, spatially relative terms, such as “beneath,” “below,” “lower,” “above,” “upper,” and the like, may be used herein for ease of description to describe one element or feature's relationship to another element or feature as illustrated in the figures. The spatially relative terms are intended to encompass different orientations of the device in use or operation in addition to the orientation depicted in the figures. The apparatus can be otherwise oriented (rotated 90 degrees or at other orientations) and the spatially relative descriptors used herein can likewise be interpreted accordingly.

Additive manufacturing, such as Laser Powder Bed Fusion (LPBF) allows a user to create a complex additively manufactured object from a CAD model. The CAD model can be input into a 3-D printer, and the printer can form parts with the user's desired shapes. The additive manufactured parts are formed by building up structural layers and fusing them together. To start an LPBF process, the print chamber is filled with inert gas and heated to an optimal printing temperature. A thin layer of a powdered material is applied to the build platform and a focused energy source (e.g., a fiber optic laser) scans the cross-section of the part and melts the metal particles together. When the first layer is finished, the platform can move downward, allowing the next layer of powder to be added, melted, and fused to the first layer. The process is repeated until the final part is obtained. The powdered raw material can be polymers or metals such as stainless steel, cobalt-chromium, aluminum, titanium, Inconel, or other suitable metals. LPBF additive manufacturing allows 3-D printed components to be made with tight tolerance and thin walls. For example, geometries of the present disclosure can have wall thicknesses between about 0.3 mm to about 2 mm.

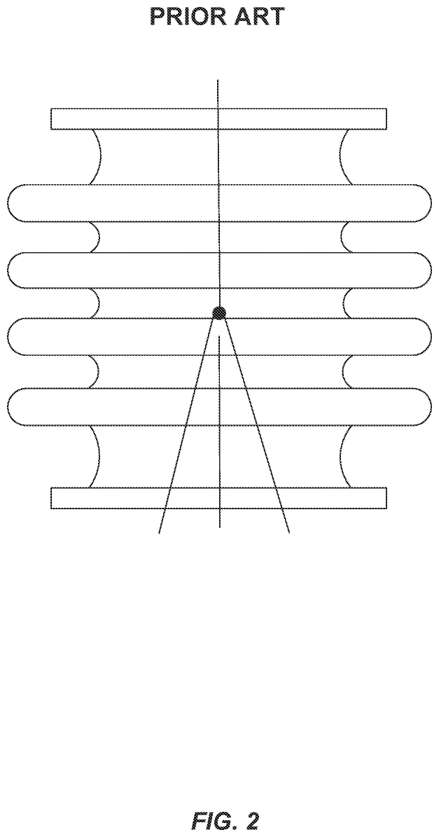

The inventors realized and discovered bellows having the three-dimensional shapes of embodiments described herein could be produced using additive manufacturing and provide stability of print when printing the bellows using an LPBF process. The embodiments described herein would be impossible to replicate using conventional methods of manufacturing and forming bellows and bellow assemblies. Conventional methods of forming bellows and bellows assemblies require that all features of the bellows have line-of-sight with a forming tool. Generally, this limits bellows assemblies to perpendicular convolutions relative to a longitudinal axis of the bellows, and other simple shapes, as shown, for example, in FIG. 2.

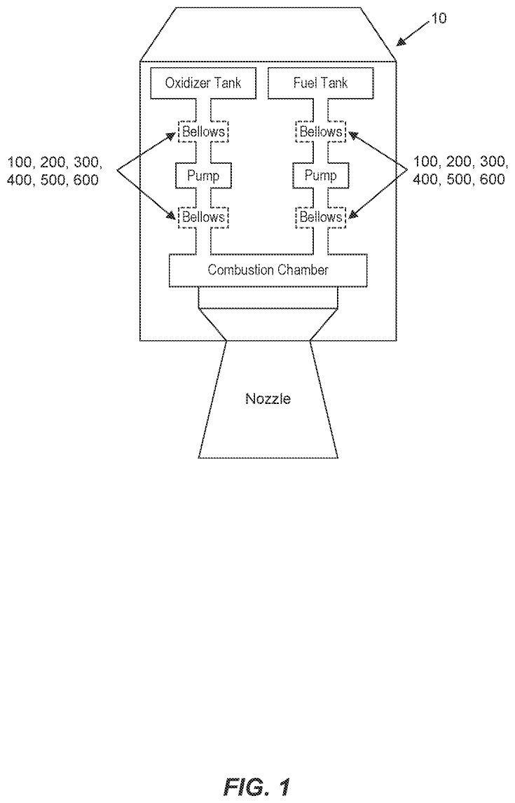

Propulsion devices use bellows to transfer liquids and gases between adjacent ducts and lines especially in arrangements that can translate or rotate relative to one another. Propulsion devices include, for example, gas turbine engines, rocket engines, and other similar applications. In some embodiments, multiple bellows can be used on a propulsion device with different requirements, as shown, for example, in FIG. 1. For example, between adjacent joining components, the bellows can allow for axial or translational movement, expansion, gimballing to allow tilt movement in any direction, and/or thrust vector control. In addition, the bellows can transfer liquid or gases at high or low pressures or act as a spring to store potential energy.

Compared with conventional bellows assemblies, embodiments of the present disclosure provide optimized bellows geometries for propulsion devices. The inventors realized and discovered that additive manufactured parts according to embodiments of the present invention have greater design freedom than formed or welded parts and therefore allow greater design iteration, short lead times, and fewer parts for a particular application. For example, the inventors realized and discovered that the bellow geometries of embodiments described herein allow for the manufacture of additional internal features to address particular needs, concerns, or conditions of a particular application or environment. The inventors further realized and discovered that, when manufacturing embodiments of the present invention, ingredients in the raw material, e.g., a metallic powder, can be modified in a controlled fashion to alter properties of the coupling as desired, while still using the same 3-D printer.

### Example Bellows Assembly

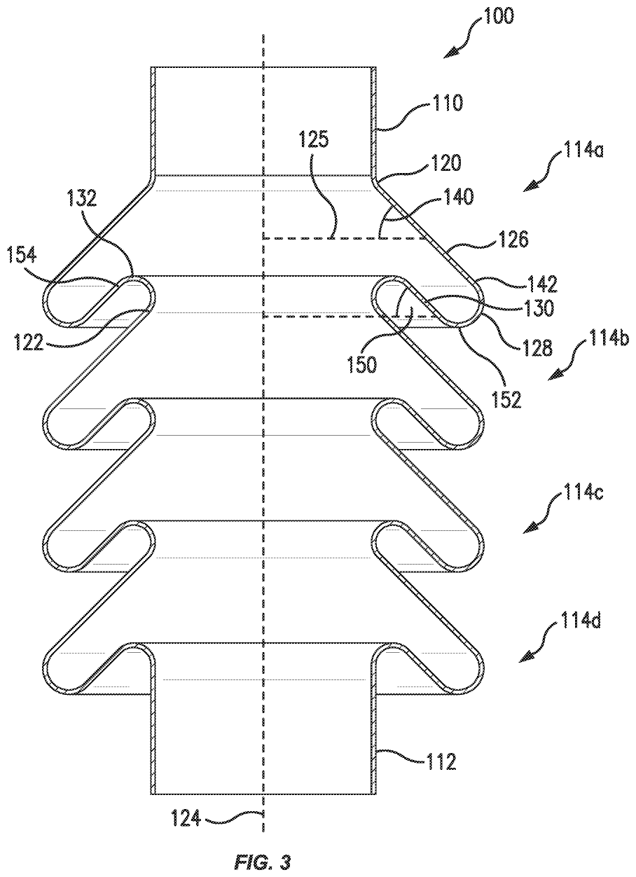

FIGS. 3-5 illustrate a cross-sectional side view of bellows assembly 100, according to at least one embodiment. Bellows assembly 100 can be coupled to adjacent components in propulsion device 10. Bellows assembly 100 includes first connecting portion 110, second connecting portion 112, and at least one convolution 114a. As shown in FIG. 3, for example, bellows assembly 100 includes four convolutions 114a,b,c,d with similar geometries stacked on top of each other along a longitudinal axis 124. In some embodiments, bellows assembly 100 can include two, three, or more than four convolutions depending on the flexibility requirements and space constraints of the application the bellows is assembled into.

First connecting portion 110 extends around the longitudinal axis 124 to form a tube as shown, for example in FIG. 3. In some embodiments, first connecting portion 110 can be additively manufactured to have a different cross-sectional shape such as a square, oval, or other polygonal shape. First connecting portion 110 can be coupled to an adjacent component, such as an exhaust duct, or fuel line, in propulsion device 10 (not shown in FIG. 3). In some embodiments, first connecting portion 110 can be coupled to the adjacent component with a flange, or by welding, fusing, or other suitable coupling method. In some embodiments, first connecting portion 110 can be integral with the adjacent component to reduce overall part count in the propulsion device 10 (not shown).

Second connecting portion 112 extends around the longitudinal axis 124 to form a tube as shown, for example, in FIG. 3. In some embodiment, second connecting portion 112 can be additively manufactured to have a different cross-sectional shape such as a square, oval, or other polygonal shape. Second connecting portion 112 can be coupled to an adjacent component, such as an exhaust duct, or fuel line, in propulsion device 10 (not shown in FIG. 3). In some embodiments, second connecting portion 112 can be coupled to the adjacent component with a flange, or by welding, fusing, or other suitable coupling method. In some embodiments, second connecting portion 112 can be integral with the adjacent component to reduce overall part count in the propulsion device 10 (not shown).

Convolution 114a extends between first connecting portion 110 and second connecting portion 112 along longitudinal axis 124. Convolution 114a can have a wall thickness between about 0.3 mm and 5 mm. In some embodiments, convolution 114a can have a wall thickness of about 0.5 mm. Convolution 114a is configured to be flexible such that first connecting portion 110 and second connecting portion 112 can move relative to one another. In some embodiments, convolution 114a expands and contracts along the longitudinal axis 124 so that first connecting member 110 and second connecting portion 112 move toward and away from each other. In some embodiments, convolution 114a and others like it, viz. 114b, 114c, 144d, allow first connecting portion 110 and second connecting portion 112 to translate radially relative to each other, perpendicular to the longitudinal axis 124. In some embodiments, convolution 114a allows for angular rotation and compliance of first connecting portion 110 relative to second connecting portion 112 such that bellows assembly 100 can gimbal and move or tilt freely in any direction.

Convolution 114a can include first end 120, second end 122, first compliant portion 126, second compliant portion 128, third compliant portion 130, and fourth compliant portion 132, as shown, for example, in FIG. 3. First end 120 connects to first connecting portion 110. Second end 122 connects to second connecting portion 112, or to a first end of an adjacent convolution 114b where bellows assembly 100 includes more than one convolution 114a.

First compliant portion 126 extends outwardly away from first end 120 to form an angled shape, in particular, an inward cone shape as shown. The inventors realized and discovered that the inward cone shape of first compliant portion 126 and associated hoop stresses allow for a stable additive manufacturing process of bellows assembly 100. First compliant portion 126 extends at first angle 140 relative to a lateral axis 125, where the lateral axis 125 is perpendicular to the longitudinal axis 124. First angle 140 can be between about 30 degrees to about 80 degrees. Second compliant portion 128 extends from a distal end 142 of first compliant portion 126 and couples to a distal end 152 of third compliant portion 130. Third compliant portion 130 extends away from second compliant portion 128 toward second end 122 and forms an inward cone shape. The inventors realized and discovered that the inward cone shape of third compliant portion 130 and associated hoop stresses allow for a stable additive manufacturing of bellows assembly 100. As shown in FIG. 3, the inward cone shapes of first compliant portion 126 and third compliant portion 130 together form an inward fold, which the inventors further realized and discovered allowed for improved packaging, as described in greater detail below. Third compliant portion 130 extends at second angle 150 relative to the lateral axis 125. Second angle 150 can be between about 30 degrees to about 80 degrees. In the illustrative embodiment shown in FIG. 3, first angle 140 and second angle 150 are equal such that first compliant portion 126 and third compliant portion 130 are spaced apart and parallel to one another. Fourth compliant portion 132 extends between and couples second end 122 and proximal end 154 of third compliant portion 130 together.

In the embodiment in FIG. 3, second end 122 is axially located between second compliant portion 128 and first end 120 such that second compliant portion 128 overlaps an adjacent convolution 114 in bellows assembly 100. Such overlapping of convolutions 114 allows for improved packaging of bellows assembly 100 relative to conventional bellows; for example, more convolutions 114 can be included in bellows assembly 100 per unit length along the longitudinal axis 124 than can be included in conventional bellows. The inventors discovered that bellows assembly 100 could have a reduced radial envelope area relative to a conventional bellows while still providing similar flexibility in axial and radial directions, and providing similar flexibility in tilting gimbal angles relative to the longitudinal axis.

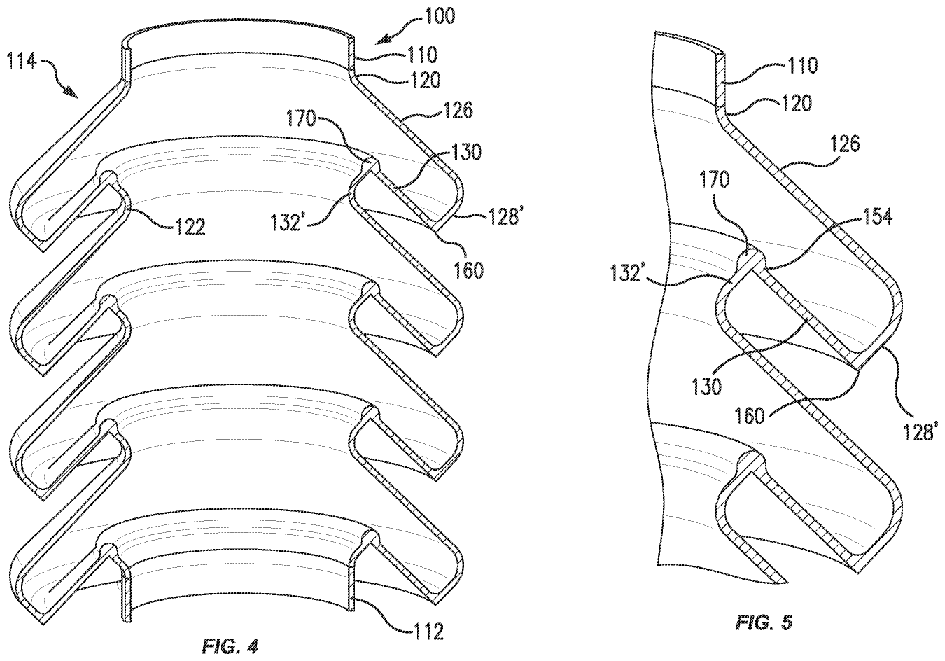

In some embodiments, second compliant portion 128 can extend between first and third compliant portions 126, 130 and be substantially arcuate with a single smooth radius, as shown, for example, in FIG. 3. As illustratively shown in FIGS. 4 and 5, the inventors discovered that extending second compliant portion 128′ between first and third compliant portions 126, 130 with a compound radii curve can improve printing stability of the first or third compliant portions 126, 130 in an additive manufacturing process. Second compliant portion 128′ can include starting portion 160 that extends away from second compliant portion 128′ approximately parallel with longitudinal axis 124. The inventors discovered that starting portion 160 improves printing yield by providing a feature to start printing convolution 114. Starting portion 160 can allow convolution 114 to be printed without support members 180. Starting portion 160 can have a sharp angle, approximately about 90 degrees.

In some embodiments, fourth compliant portion 132 can extend between second compliant portion 128 and second end 122 and be substantially arcuate with a single smooth radius, as shown, for example, in FIG. 3. As illustratively shown in FIGS. 4 and 5, fourth compliant portion 132′ can extend at approximately 90 degrees from third compliant portion 130 and couple with second end 122 with a smooth radius. The inventors discovered that the foregoing configuration of fourth compliant portion 132′ provides high printing stability of third compliant portion 130 in an additive manufacturing process. Fourth compliant portion 132′ can include stiffening portion 170 that extends away from fourth compliant portion 132′ approximately parallel with longitudinal axis 124. Stiffening portion 170 can locally stiffen convolution 114a such that compliance of convolution 114a comes from first and third compliant portions 126, 130. Stiffening portion 170 can provide additional material in fourth compliant portion 132′ to accommodate stresses in convolution 114a due to bending and movement of first connecting portion 110 relative to second connecting portion 112.

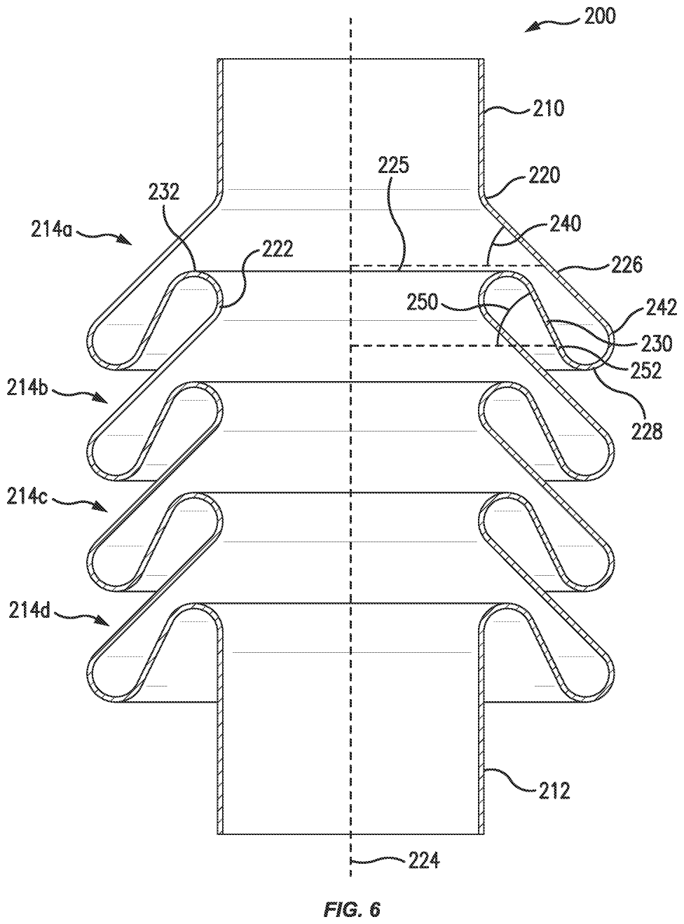

FIGS. 6-8 provide another embodiment of a bellows assembly 200 in accordance with the present disclosure and show a different convolution 214 configuration. Bellows assembly 200 is substantially similar to bellows assembly 100 shown in FIGS. 3-5 and described herein. Accordingly, similar reference numbers in the 200 series indicate commonalities between bellows assembly 200 and bellows assembly 100. The description of bellows assembly 100 above is incorporated by reference to apply to bellows assembly 200, except in instances when it conflicts with the specific description and the drawings of bellows assembly 200.

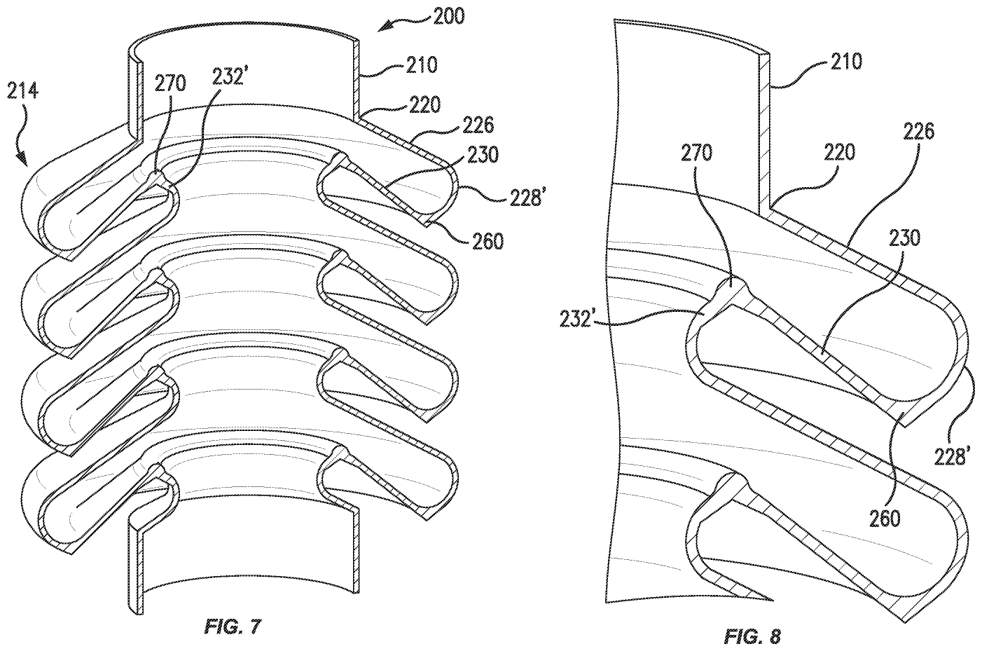

Bellows assembly 200 includes first connecting portion 210, second connecting portion 212, and at least one convolution 214. As shown in FIGS. 6 and 7, for example, bellows assembly 200 can include four convolutions 214 with similar geometries stacked on top of each other along a longitudinal axis 224, but more or fewer convolutions 214 can also be possible. First connecting portion 210 extends around the longitudinal axis 224 to form a tube. Second connecting portion 212 extends around the longitudinal axis 224 to form a tube.

Convolution 214 extends between first connecting portion 210 and second connecting portion 212 along longitudinal axis 224 as shown, for example in FIGS. 6 and 7. Convolution 214 is configured to be flexible such that first connecting portion 210 and second connecting portion 212 can move relative to one another. Convolution 214 can include first end 220, second end 222, first compliant portion 226, second compliant portion 228, third compliant portion 230, and fourth compliant portion 232. First end 220 connects to first connecting portion 210. Second end 222 connects to second connecting portion 212, or to a first end of an adjacent convolution where bellows assembly 200 includes more than one convolution 214.

First compliant portion 226 extends outwardly away from first end 220 to form an inward cone shape. First compliant portion 226 extends at first angle 240 relative to a lateral axis 225, where the lateral axis 225 is perpendicular to longitudinal axis 224. First angle 240 can be between about 30 degrees to about 80 degrees relative to the lateral axis 225. Second compliant portion 228 extends from a distal end 242 of first compliant portion 226 and couples to a distal end 252 of third compliant portion 230. Third compliant portion 230 extends away from second compliant portion 228 toward second end 222 and forms an inward cone shape. Third compliant portion 230 extends at second angle 250 relative to the lateral axis 225. Second angle 250 can be between about 30 degrees to about 80 degrees relative to the lateral axis 225. In the illustrative embodiment shown in FIG. 6, first angle 240 is different from second angle 250. In some embodiments, first angle 240 is greater than second angle 250 such that distal ends 242, 252 are spaced further apart than proximal end 254 of third compliant portion 230 and first compliant portion 226. In some embodiments, first angle 240 can be less than second angle 250. Fourth compliant portion 232 extends between and couples second end 222 and proximal end 254 of third compliant portion 230 together.

In the illustrative embodiment in FIG. 6, second end 222 is axially located between second compliant portion 228 and first end 220 such that second compliant portion 228 overlaps an adjacent convolution 214 in bellows assembly 200. The inventors realized and discovered that such overlapping of convolutions 214 allows for improved packaging of bellows assembly 200 relative to conventional bellows. In addition, the inventors realized and discovered that first angle 240 and second angle 250 of convolutions 214 allows for increased flexibility of bellows assembly 200 compared to bellows assembly 100. They also realized and discovered that bellows assembly 200 can have increased convolutions 214 per unit length compared to bellows assembly 100, thereby providing improved packaging of the bellows assembly 200 compared to bellows 100.

In embodiments, second compliant portion 228 may have a substantially arcuate shape. As used herein, “substantially arcuate” or a “substantially arcuate shape” may refer to a shape that forms an arch or a geometrical feature that is curved in the form of a bow or to the extent of a quadrant of a circle or more. In some embodiments, second compliant portion 228 can extend between first and third compliant portions 226, 230 and be substantially arcuate with a single smooth radius, as shown, for example, in FIG. 6. As illustratively shown in FIGS. 7 and 8, second compliant portion 228′ can extend between first and third compliant portions 226, 230 with a compound radii curve to improve printing stability convolution 214. Second compliant portion 228′ can include starting portion 260 that extends away from second compliant portion 228′ approximately parallel with longitudinal axis 224. Starting portion 260 can have a sharp angle, approximately about 90 degrees.

In embodiments, fourth compliant portion 232 may have a substantially arcuate shape. In some embodiments, fourth compliant portion 232 can extend between third compliant portion 230 and second end 222 and be substantially arcuate with a single smooth radius, as shown, for example, in FIG. 6. As illustratively shown in FIGS. 7 and 8, fourth compliant portion 232′ can extend at approximately 90 degrees from third compliant portion 230 and couple with second end 222 with a smooth radius to provide high printing stability of convolution 214. Fourth compliant portion 232′ can include stiffening portion 270 that extends away from fourth compliant portion 232′ approximately parallel with longitudinal axis 224. Stiffening portion 270 can locally stiffen convolution 214 such that compliance of convolution 214 comes from first and third compliant portions 226, 230.

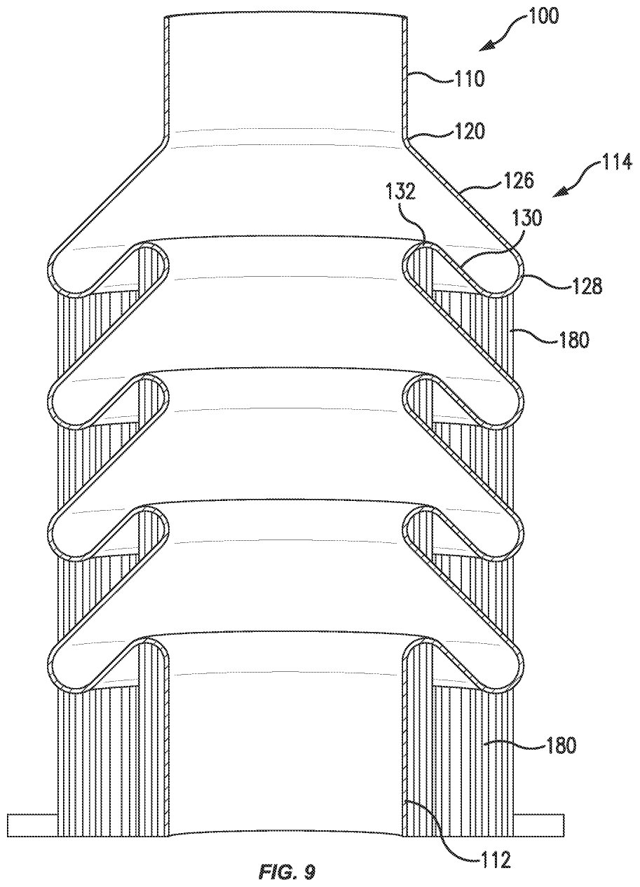

During manufacture of bellows assembly 100 or bellows assembly 200, structural members 180, as shown, for example, in FIG. 9, can be used to improve printing yields. Structural members 180 provide support to convolution 114 during printing and can be snapped off or cut from convolution 114 after printing.

### Example Bellows Assembly with Double Overlapping Convolutions

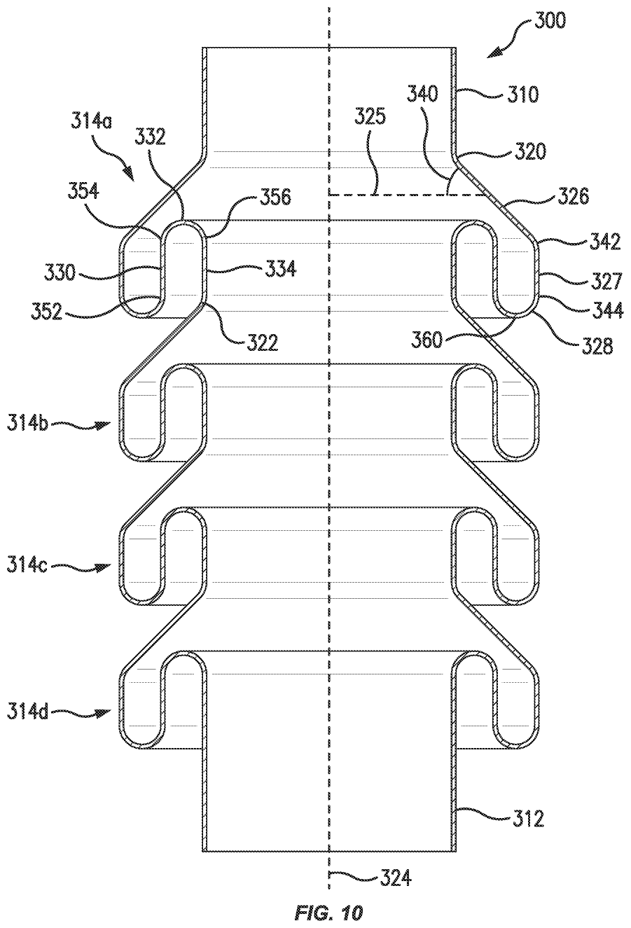

Another embodiment of a bellows assembly 300 in accordance with the present disclosure is shown in FIG. 10 showing a different convolution 314 configuration. Bellows assembly 300 is substantially similar to bellows assembly 100 shown in FIGS. 3-5 and described herein. Accordingly, similar reference numbers in the 300 series indicate commonalities between bellows assembly 300 and bellows assembly 100. The description of bellows assembly 100 is incorporated by reference to apply to bellows assembly 300, except in instances when it conflicts with the specific description and the drawings of bellows assembly 300.

FIG. 10 illustrates a cross-sectional side view of bellows assembly 300, according to embodiments. Bellows assembly 300 can be coupled to adjacent components in propulsion device 10. Bellows assembly 300 includes first connecting portion 310, second connecting portion 312, and at least one convolution 314. As shown in FIG. 10, for example, bellows assembly 300 includes four convolutions 314 with similar geometries stacked on top of each other along a longitudinal axis 324, but more or fewer convolutions 314 can also be possible. First connecting portion 310 extends around the longitudinal axis 324 to form a tube. Second connecting portion 312 extends around the longitudinal axis 324 to form a tube.

Convolution 314 extends between first connecting portion 310 and second connecting portion 312 along longitudinal axis 324 as shown, for example in FIG. 10. Convolution 314 is configured to be flexible such that first connecting portion 310 and second connecting portion 312 can move relative to one another. Convolution 314 can include first end 320, second end 322, first compliant portion 326, first tube portion 327, second tube portion 328, second compliant portion 330, third tube portion 332, and third compliant portion 334. First end 320 connects to first connecting portion 310. Second end 322 connects to second connecting portion 312, or to a first end of an adjacent convolution where bellows assembly 300 includes more than one convolution 314.

First compliant portion 326 extends outwardly away from first end 320 to form an inward cone shape. First compliant portion 326 extends at first angle 340 relative to a lateral axis 325, where the lateral axis 325 is perpendicular to the longitudinal axis 324. First angle 340 can be between about 30 degrees to about 80 degrees relative to the lateral axis 325. First tube portion 327 extends away from a distal end 342 of first compliant portion 326 approximately parallel to the longitudinal axis 324, such that first tube portion 327 forms a tube. Second compliant portion 330 extends from a distal end 344 of first tube portion 327 and couples to a distal end 352 of second tube portion 328. Second tube portion 328 extends away from second compliant portion 330 approximately parallel to longitudinal axis 324, such that second tube portion 328 forms a tube. Third compliant portion 334 extends from a proximal end 354 of second tube portion 328 and couples to a proximal end 356 of third tube portion 332. Third tube portion 332 extends away from third compliant portion 334 approximately parallel to longitudinal axis 324, such that third tube portion 332 forms a tube. Third tube portion 332 extends to and couples with second end 322.

In the illustrative embodiment in FIG. 10, first tube portion 327, second tube portion 328, and third tube portion 332 are equally spaced apart in the radial direction. In some embodiments, first tube portion 327 can be spaced apart from second tube portion 328 by a first distance, and second tube portion 328 can be spaced apart from third tube portion 332 by a second distance different from the first distance. In some embodiments, first tube portion 327, second tube portion 328, and third tube portion 330 can be approximately aligned along the longitudinal axis 324. In some embodiments, first tube portion 327, second tube portion 328, and third tube portion 332 can extend at an angle relative to the lateral axis 325 such that each of first, second, and third tube portions 327, 328, 332 form inward extending cones similar to bellows assembly 100 described above. In some embodiments, first, second, and third tube portions 327, 328, 332 can extend at different angles relative to the lateral axis 325 similar to bellows assembly 200 described above. The inventors realized and discovered that such radially overlapping of convolutions 314 can allow for improved packaging of bellows assembly 300 relative to conventional bellows. For example, bellows assembly 300 can have more radial compliance for a unit length than a conventional bellows or bellows assemblies 100, 200.

In some embodiments, second compliant portion 330 can include starting portion 360 that extends away from second compliant portion 330 approximately parallel with longitudinal axis 324. Starting portion 360 can have a sharp angle, approximately about 90 degrees, to improve the initial additive manufacturing of convolution 314.

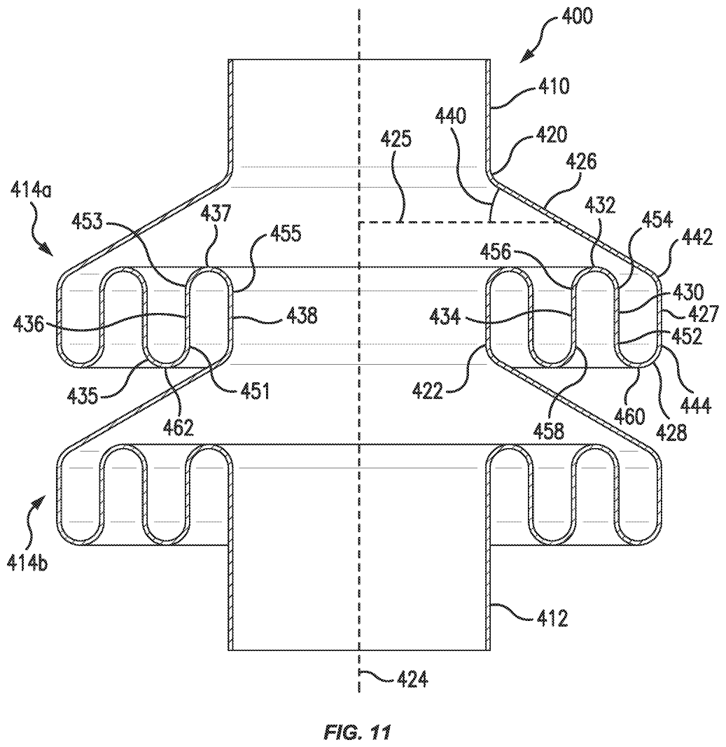

Another embodiment of a bellows assembly 400 in accordance with the present disclosure is shown in FIG. 11 showing a different convolution 414 configuration. Bellows assembly 400 is substantially similar to bellows assembly 100 shown in FIGS. 3-5 and described herein. Accordingly, similar reference numbers in the 400 series indicate commonalities between bellows assembly 400 and bellows assembly 100. The description of bellows assembly 100 is incorporated by reference to apply to bellows assembly 400, except in instances when it conflicts with the specific description and the drawings of bellows assembly 400.

FIG. 11 illustrates a cross-sectional side view of bellows assembly 400, according to embodiments. Bellows assembly 400 can be coupled to adjacent components in propulsion device 10. Bellows assembly 400 includes first connecting portion 410, second connecting portion 412, and at least one convolution 414. As shown in FIG. 11, for example, bellows assembly 400 includes two convolutions 414 with similar geometries stacked on top of each other along a longitudinal axis 424, but more convolutions 414 can also be possible. First connecting portion 410 extends around the longitudinal axis 424 to form a tube. Second connecting portion 412 extends around the longitudinal axis 424 to form a tube.

Convolution 414 extends between first connecting portion 410 and second connecting portion 412 along longitudinal axis 424 as shown, for example in FIG. 11. Convolution 414 is configured to be flexible such that first connecting portion 410 and second connecting portion 412 can move relative to one another. Convolution 414 can include first end 420, second end 422, first compliant portion 426, first tube portion 427, second tube portion 428, second compliant portion 430, third tube portion 432, third compliant portion 434, fourth tube portion 436, fourth compliant portion 437, fifth tube portion 438, and fifth compliant portion 439. First end 420 connects to first connecting portion 410. Second end 422 connects to second connecting portion 412, or to a first end of an adjacent convolution where bellows assembly 400 includes more than one convolution 414.

First compliant portion 426 extends outwardly away from first end 420 to form an inward cone. First compliant portion 426 extends at first angle 440 relative to a lateral axis 425, where the lateral axis 425 is perpendicular to the longitudinal axis 424. First angle 440 can be between about 30 degrees to about 80 degrees relative to the lateral axis 425. First tube portion 427 extends away from a distal end 442 of first compliant portion 426 approximately parallel to the longitudinal axis 424, such that first tube portion 427 forms a tube. Second compliant portion 430 extends from a distal end 444 of first tube portion 427 and couples to a distal end 452 of second tube portion 428. Second tube portion 428 extends away from second compliant portion 430 approximately parallel to longitudinal axis 424, such that second tube portion 428 forms a tube. Third compliant portion 434 extends from a proximal end 454 of second tube portion 428 and couples to a proximal end 456 of third tube portion 432. Third tube portion 432 extends away from third compliant portion 434 approximately parallel to longitudinal axis 424, such that third tube portion 432 forms a tube. Fourth compliant portion 437 extends from a distal end 458 of third tube portion 432 and couples to a distal end 451 of fourth tube portion 436. Fourth tube portion 436 extends away from fourth compliant portion 437 approximately parallel to longitudinal axis 424, such that fourth tube portion 436 forms a tube. Fifth compliant portion 439 extends from a proximal end 453 of fourth tube portion 436 and couples to a proximal end 455 of fifth tube portion 438. Fifth tube portion 438 extends away from fifth compliant portion 439 approximately parallel to longitudinal axis 424, such that fifth tube portion 438 forms a tube. Fifth tube portion 438 extends to and couples with second end 422.

In the illustrative embodiment in FIG. 11, first, second, third, fourth, and fifth tube portions 427, 428, 432, 436, 438 are equally spaced apart in the radial direction and parallel to one another. In some embodiments, first, second, third, fourth, and fifth tube portions 427, 428, 432, 436, 438 are parallel to one another and spaced apart by differing distances. In some embodiments, first, second, third, fourth, and fifth tube portions 427, 428, 432, 436, 438 can be approximately aligned along the longitudinal axis 324. In some embodiments, first, second, third, fourth, and fifth tube portions 427, 428, 432, 436, 438 can extend at an angle relative to the lateral axis 425 such that each of first, second, third, fourth, and fifth tube portions 427, 428, 432, 436, 438 form inward extending cones similar to bellows assembly 100 described above. In some embodiments, first, second, third, fourth, and fifth tube portions 427, 428, 432, 436, 438 can extend at different angles relative to the lateral axis 425 similar to bellows assembly 200 described above. The inventors realized and discovered that such radially overlapping of convolutions 414 can allow for improved packaging of bellows assembly 400 relative to conventional bellows. For example, bellows assembly 400 can have more radial compliance for a unit length than a conventional bellows, or bellows assemblies 100, 200, 300.

In some embodiments, second compliant portion 430 can include starting portion 460 that extends away from second compliant portion 430 approximately parallel with longitudinal axis 424. In some embodiments, fourth compliant portion 436 can include starting portion 462 that extends away from fourth compliant portion 436 approximately parallel with longitudinal axis 424. Starting portions 460, 462 can have sharp angles, approximately about 90 degrees, to improve the initial printing process of convolution 414.

### Example Spiral Bellows Assembly

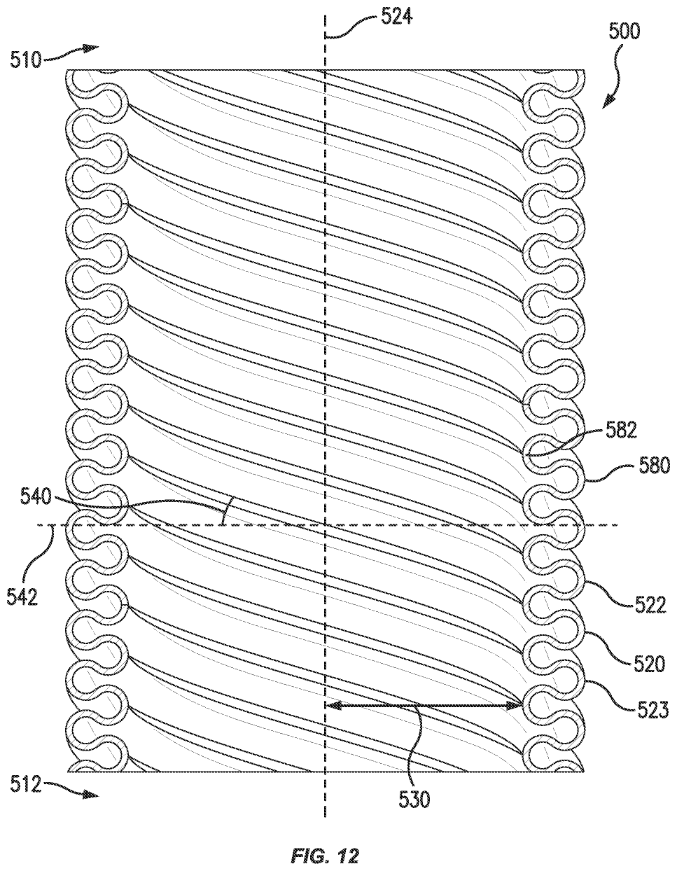

FIGS. 12-14 illustrate bellows assembly 500, according to embodiments. Bellows assembly 500 can be coupled to adjacent components in propulsion device 10. Bellows assembly 500 includes first connecting portion 510, second connecting portion 512, and helix convolution 514. Helix convolution 514 can include between about four and twelve individual adjoining convolutions, circumferentially spaced apart and parallel to one another, and extending between the first and second connecting portions 510, 512 to form the helix shape. In some embodiments, bellows assembly 500 is additively manufactured.

First connecting portion 510 (not shown) can extend around the longitudinal axis 524 to form a tube. First connecting portion 510 can be coupled to an adjacent component, such as an exhaust duct, or fuel line, in propulsion device 10. In some embodiments, first connecting portion 510 can be coupled to the adjacent component with a flange, or by welding, fusing, or other suitable coupling method. In some embodiments, first connecting portion 510 can be integral with the adjacent component to reduce overall part count in the propulsion device 10.

Second connecting portion 512 (not shown) can extend around the longitudinal axis 524 to form a tube. Second connecting portion 512 can be coupled to an adjacent component, such as an exhaust duct, or fuel line, in propulsion device 10. In some embodiments, second connecting portion 512 can be coupled to the adjacent component with a flange, or by welding, fusing, or other suitable coupling method. In some embodiments, second connecting portion 512 can be integral with the adjacent component to reduce overall part count in the propulsion device 10.

Helix convolution 514 extends between first connecting portion 510 and second connecting portion 512 along longitudinal axis 524. Helix convolution 514 can have a wall thickness between about 0.3 mm and 5 mm. In some embodiments, helix convolution 514 can have a wall thickness of about 0.5 mm. Helix convolution 514 can be configured to be flexible such that first connecting portion 510 and second connecting portion 512 can move relative to one another. In some embodiments, helix convolution 514 expands and contracts along the longitudinal axis 524 so that first connecting member 510 and second connecting portion 512 move toward and away from each other. In some embodiments, helix convolution 514 allows first connecting portion 510 and second connecting portion 512 to translate radially relative to each other, perpendicular to the longitudinal axis 524. In some embodiments, convolution 514 allows for angular rotation and compliance of first connecting portion 510 relative to second connecting portion 512 such that bellows assembly 500 can gimbal or tilt by an angle relative to longitudinal axis 524. In some embodiments, convolution 514 allows for torsional angular rotation of first connecting portion 510 relative to second connecting portion 512 such that bellows assembly 500 provides a torsional angular compliance between adjacent component of the propulsion device 10.

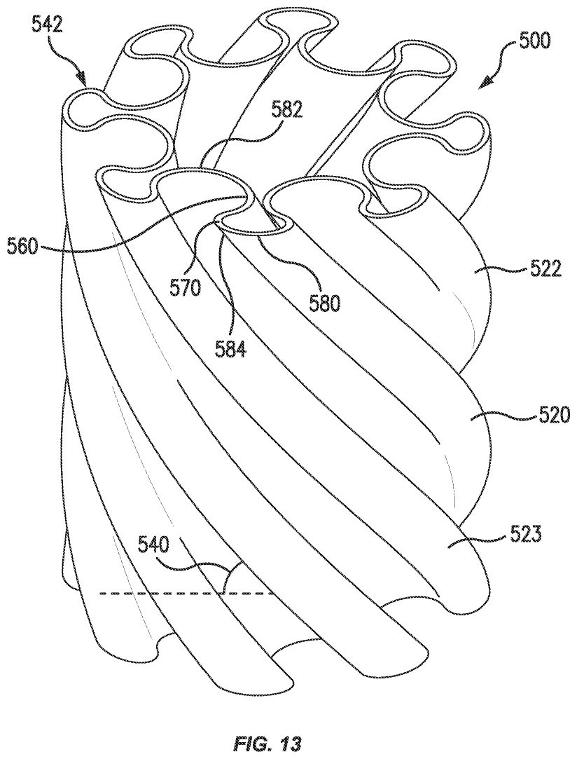

Helix convolution 514 can include a plurality of individual helixes circumferentially spaced apart and extending around longitudinal axis 524 parallel to one another as shown for example in FIGS. 12 and 13. A first helix 520 of the plurality of helixes can have similar geometry to adjacent helixes 522, 523 of the plurality of individual helixes. In some embodiments, first helix can have different geometry to adjacent helixes 522, 523 of the plurality of helixes. In some embodiments, the number of helixes in helix convolution 514 can be constrained by a radius 530 of the bellows assembly 500. For example, as radius 530 of helix convolution 514 increases, the number of helixes arranged around the circumference of helix convolution 514 can also increase. Alternatively, as radius 530 of helix convolution 514 decreases, the number of helixes that can be arranged around the circumference of helix convolution 514 can also decrease. In some embodiments, the number of helixes in helix convolution 514 can be a function of the desired flexibility of bellows assembly 500. More helixes can provide a stiffer bellows assembly, fewer helixes can provide a more flexible bellows assembly. In some embodiments, the number of helixes in helix convolution 514 can be a function of a desired weight and/or cost of bellows assembly 500.

First helix 520 is spaced apart from the longitudinal axis 524 by radius 530 and extends circumferentially around longitudinal axis 524 as shown, for example, in FIGS. 12 and 13. As first helix 520 extends circumferentially around longitudinal axis 524, first helix 520 increases in height along longitudinal axis 524 such that first helix 520 extends at a first angle 540 relative to plane 542. Plane 542 is perpendicular to longitudinal axis 524. In some embodiments, plane 542 can be horizontal and longitudinal axis 524 can be vertical during additive manufacturing of bellows assembly 500. In some embodiments, first angle 540 can be between about 10 degrees and about 30 degrees. In the embodiment shown in FIG. 13, helix convolution 514 can have steeper convolutions to provide increased torsional flexibility and/or more stable printing of bellows assembly 500, with first angle between about 30 degrees and about 60 degrees. In the illustrative embodiment in FIG. 12, first angle 540 is consistent along the length of helix convolution 514. In some embodiments, a lower first angle 540 provides more longitudinal and lateral flexibility of bellows assembly 500.

As shown, for example, in FIG. 13, first helix 520 has a cross-section parallel to plane 542 that includes a concave portion 560 and a convex portion 570. Each of adjacent helixes 522, 523, of helix convolution 514 have similar cross-sectional shape to first helix 520. Convex portion 570 extends from an outer radius portion 580 of helix convolution 514 inward toward concave portion 560. Convex portion 570 is at an overhang portion 584 of first helix 520. The inventors realized and discovered that using smaller local radii of convex portion 570 or increased first angle 540 of first helix 520 would increase printing stability and manufacturing yield of bellows assembly 500, and to avoid melt-pool instability in overhang portion 584. Concave portion 560 extends inwardly away from convex portion 570 with opposite curvature to convex portion 570 and toward inner radius portion 582. Concave portion 560 can have larger radius than convex portion while maintaining high printing stability during additive manufacturing. Concave portion 560 is supported by inner radius portion 582 and convex portion 570 and can have more stable printing properties than convex portion 570.

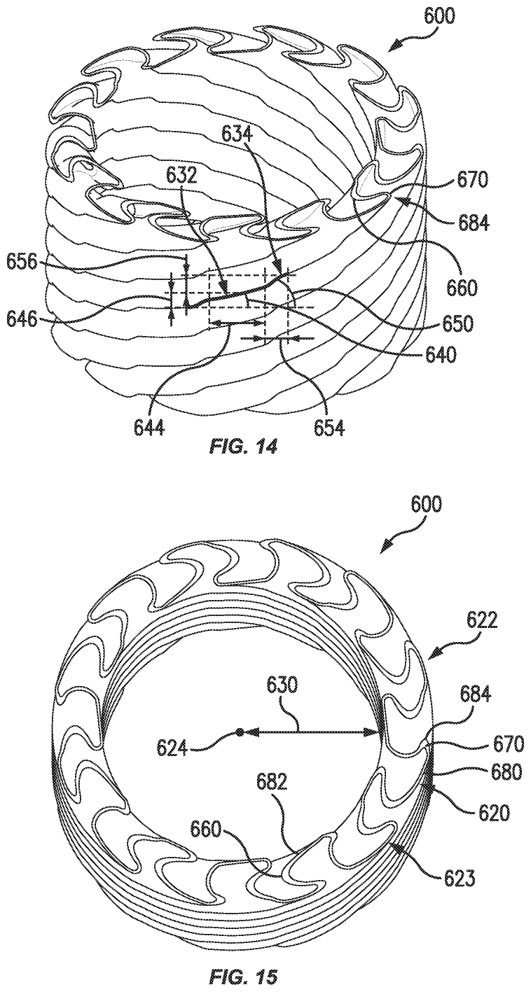

Another embodiment of a bellows assembly 600 in accordance with the present disclosure is shown in FIGS. 14 and 15 showing a different helix convolution 614 configuration. Bellows assembly 600 is substantially similar to bellows assembly 500 shown in FIGS. 12 and 13 and described herein. Accordingly, similar reference numbers in the 600 series indicate commonalities between bellows assembly 600 and bellows assembly 500. The description of bellows assembly 500 is incorporated by reference to apply to bellows assembly 600, except in instances when it conflicts with the specific description and the drawings of bellows assembly 600.

FIGS. 14 and 15 illustrate bellows assembly 600, according to embodiments. Bellows assembly 600 can be coupled to adjacent components in propulsion device 10. Bellows assembly 600 includes first connecting portion 610, second connecting portion 612, and helix convolution 614. Helix convolution 614 can include between about four and twelve individual convolutions, circumferentially spaced apart and parallel to one another, and extending between the first and second connecting portions 610, 612 to form the helix shape. In some embodiments, bellows assembly 600 is additively manufactured.

First connecting portion 610 (not shown) can extend around the longitudinal axis 624 to form a tube. First connecting portion 610 can be coupled to an adjacent component, such as an exhaust duct, or fuel line, in propulsion device 10. In some embodiments, first connecting portion 610 can be coupled to the adjacent component with a flange, or by welding, fusing, or other suitable coupling method. In some embodiments, first connecting portion 610 can be integral with the adjacent component to reduce overall part count in the propulsion device 10.

Second connecting portion 612 (not shown) can extend around the longitudinal axis 624 to form a tube. Second connecting portion 612 can be coupled to an adjacent component, such as an exhaust duct, or fuel line, in propulsion device 10. In some embodiments, second connecting portion 612 can be coupled to the adjacent component with a flange, or by welding, fusing, or other suitable coupling method. In some embodiments, second connecting portion 612 can be integral with the adjacent component to reduce overall part count in the propulsion device 10.

Helix convolution 614 extends between first connecting portion 610 and second connecting portion 612 along longitudinal axis 624. Helix convolution 614 can have a wall thickness between about 0.3 mm and 5 mm. In some embodiments, helix convolution 614 can have a wall thickness of about 0.5 mm. Helix convolution 614 can be configured to be flexible such that first connecting portion 610 and second connecting portion 612 can move and translate relative to one another similar to bellows assembly 500 described above.

Helix convolution 614 can include a plurality of individual helixes 620, 622, 623 circumferentially spaced apart and extending around longitudinal axis 624 parallel to one another as shown for example in FIGS. 14 and 15. A first helix 620 of the plurality of helixes can have similar geometry to adjacent helixes 622, 623 of the plurality of individual helixes. In some embodiments, first helix can have different geometry to adjacent helixes 622, 623 of the plurality of helixes. In some embodiments, the number of helixes in helix convolution 614 can be constrained by a radius 630 of the bellows assembly 600. In some embodiments, the number of helixes in helix convolution 614 can be a function of the desired flexibility of bellows assembly 600.

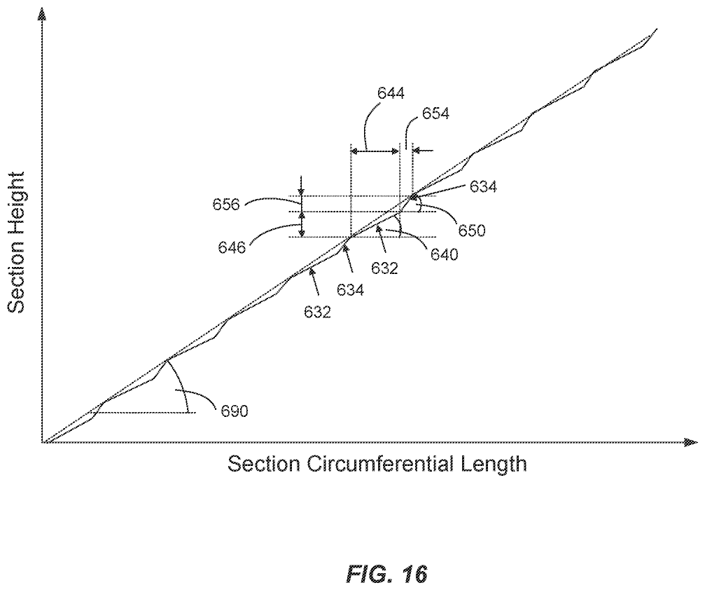

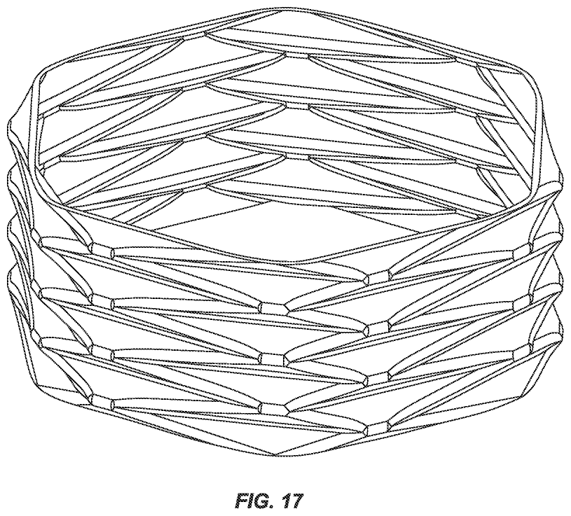

First helix 620 is spaced apart from the longitudinal axis 624 by radius 630 and extends circumferentially around longitudinal axis 624 as shown, for example, in FIGS. 14 and 15. As first helix 620 extends circumferentially around longitudinal axis 624, first helix 620 increases in height along longitudinal axis 624. First helix 620 includes first section 632 and second section 634. First section 632 extends at a first angle 640 relative to plane 642 and extends around longitudinal axis 624 for a first circumferential length 644. The first angle 640 and first circumferential length 642 result in first section 632 having a first height 646 along longitudinal axis 624. In some embodiments, first angle 640 can be between about 10 degrees and about 30 degrees. In the illustrative embodiment shown in FIG. 14, first angle 640 is about 20 degrees relative to plane 642. In some embodiments, first height 646 of first section 632 is between about 2 mm and about 12 mm. In the illustrative embodiment shown in FIG. 14, first height 646 is about 5 mm. First angle 640, first circumferential length 644, and first height 646 are illustratively shown in a graphical view in FIG. 16.

Second section 634 extends at a second angle 650 relative to plane 642 and extends around longitudinal axis 624 for a second circumferential length 654. The second angle 650 and second circumferential length 654 result in second section 634 having a second height 656 along longitudinal axis 624. In some embodiments, second angle 650 is greater than first angle 640. The inventor realized and discovered that a configuration in which second angle 650 is greater than that of first angle 640 can allow second section 634 to have more stable printing properties to provide bellows assembly 600 with a robustness during manufacture. In some embodiments, second angle 650 can be between about 30 degrees and about 60 degrees. In the illustrative embodiment shown in FIGS. 14 and 16, second angle 650 is about 45 degrees relative to plane 642. In some embodiments, second height 656 of second section 634 is between about 2 mm and about 7 mm. In the illustrative embodiment shown in FIG. 14, second height 656 is about 2 mm.

First helix 620 extends between first connecting portion 610 and second connecting portion 612 with alternating first and second sections 632, 634 as shown, for example, in FIG. 14. For example, first section 632 can extend from second connecting portion 612, and then second section 634 can extend from first section 632, then a first section 632 and second section 634 extend therefrom. First and section sections 632, 634 of first helix 620 can alternate and extend from one another along longitudinal axis 624 until first helix 620 couples to first connecting portion 610. As a result, first helix 620 has a stepped shape as it extends between first and second connecting portions 610, 612. As illustratively shown in FIG. 16, first helix 620 has an average angle 690 relative to plane 642 based on the combinations of the first and second sections 632, 634 and the relative geometries of each of first and second sections 632, 634. In the illustrative embodiment shown in FIG. 14, helix convolution 614 has an average angle 690 of about 24 degrees, where first angle is about 20 degrees, first height is about 5 mm, second angle is about 45 degree, and second height is about 2 mm. In some embodiments, helix convolution can have an average angle 690 between about 15 degrees and about 30 degrees. The inventors realized and discovered that a lower average angle 690 increases the flexibility of bellows assembly 600. Geometries of first and second sections 632, 634 can be optimized for printability, manufacturing yield, and flexibility of bellows assembly 600.

As shown, for example, in FIG. 15, first helix 620 has a cross-section parallel to plane 642 that includes a concave portion 660 and a convex portion 670. Each of adjacent helixes 622, 623, of helix convolution 614 have similar cross-sectional shape to first helix 620, but at a given cross-section along longitudinal axis 624, each helix 620, 622, 623 can appear different. The difference in appearance is based on the compound first and second section 632, 634 geometries along longitudinal axis 624 and relative locations of first section 632 and/or second section 634 for the location where the cross-section is taken.

Convex portion 670 extends from an outer radius portion 680 of helix convolution 614 inward toward concave portion 660. The inventors realized and discovered that using smaller local radii of convex portion 670 or increased first and second angles 640, 650 of first helix 620 would increase printing stability and manufacturing yield of bellows assembly 600, and to avoid melt-pool instability in overhang portion 684. Concave portion 660 extends inwardly away from convex portion 670 with opposite curvature to convex portion 670 and toward inner radius portion 682. Concave portion 660 can have larger radius than convex portion 670 while maintaining high printing stability during additive manufacturing. Concave portion 660 is supported by inner radius portion 682 and convex portion 670 and has more stable printing properties than convex portion 670.

Bellows assembly 500 and bellows assembly 600 can provide a flexible bellow design with geometry to increase printing stability and additive manufacturing yields of the design. Bellows assembly 500 and bellows assembly 600 can provide geometry that do not need additional supports during manufacture. Helix convolutions 514, 614 can allow the walls of the print to overlap without creating sharp overhangs, which can allow the bellows assemblies 500, 600 to be printed without supports.

The cross section of helix convolutions 514, 614 can minimize the curvature or radius of the convex portions 570, 670 of outcropping sections 584, 684 of the bellows assembly 500, 600. The reduced curvature can decrease warp up, material shape changes caused by heat, or decrease printing instability of convex portions 570, 670. As such, low first angles 540, 640, approximately 20 degrees, can be used for convex portions 570, 670 to print smooth overhangs 584, 684 without the need for supports.

Bellows assembly 600 can have varied overhang angle 640, 650 throughout the print. By alternating between, for example, about a 5 mm first height 646 with about a 20 degree first angle 640 overhang and about a 2 mm second height 656 and about a 45 degree second angle 650 overhang, the bellows assembly 600 can be printed with fewer undesirable overhang errors. This alternating overhang angle 640, 650 can allow for a continuous unsupported overhang angle 690 of about 24 degrees as shown, for example, in FIG. 16. The ability to print sharper overhangs 684 can allow for more wall overlap in the bellows assembly 600, which can result in less stiffness for the same part volume.

### Example Bellows Assembly with Circumferential Starter Members

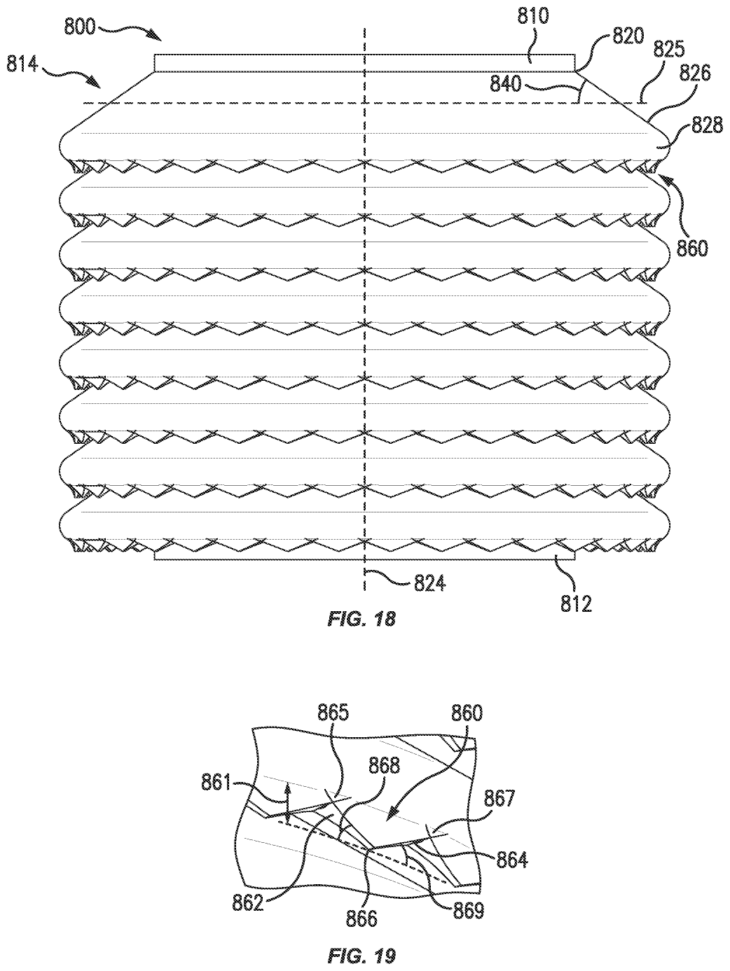

FIGS. 18-21 provide another embodiment of a bellows assembly 800 in accordance with the present disclosure and shows a different convolution 814 configuration. Bellows assembly 800 is substantially similar to bellows assembly 200 shown in FIGS. 6-8 and described herein. Accordingly, similar reference numbers in the 800 series indicate commonalities between bellows assembly 800 and bellows assembly 200. The description of bellows assembly 200 above is incorporated by reference to apply to bellows assembly 800, except in instances when it conflicts with the specific description and the drawings of bellows assembly 800.

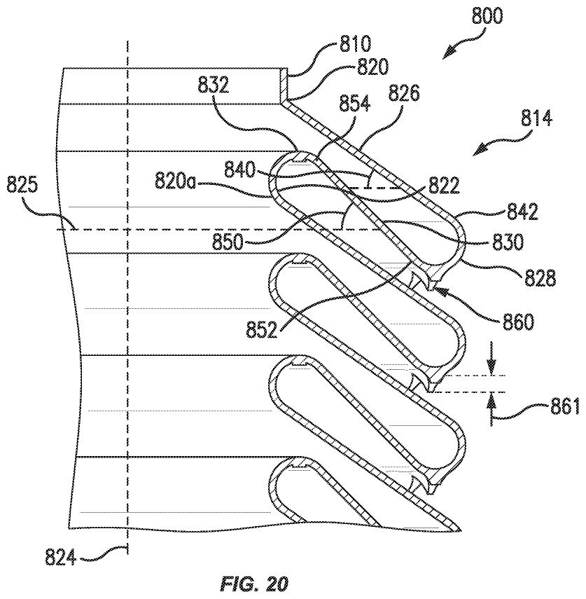

Bellows assembly 800 includes first connecting portion 810, second connecting portion 812, and at least one convolution 814 as shown in FIGS. 18 and 20. In the illustrative embodiment in FIG. 18, bellows assembly 800 can include eight convolutions 814 with similar geometries stacked on top of each other along a longitudinal axis 824, but more or fewer convolutions 814 can also be possible.

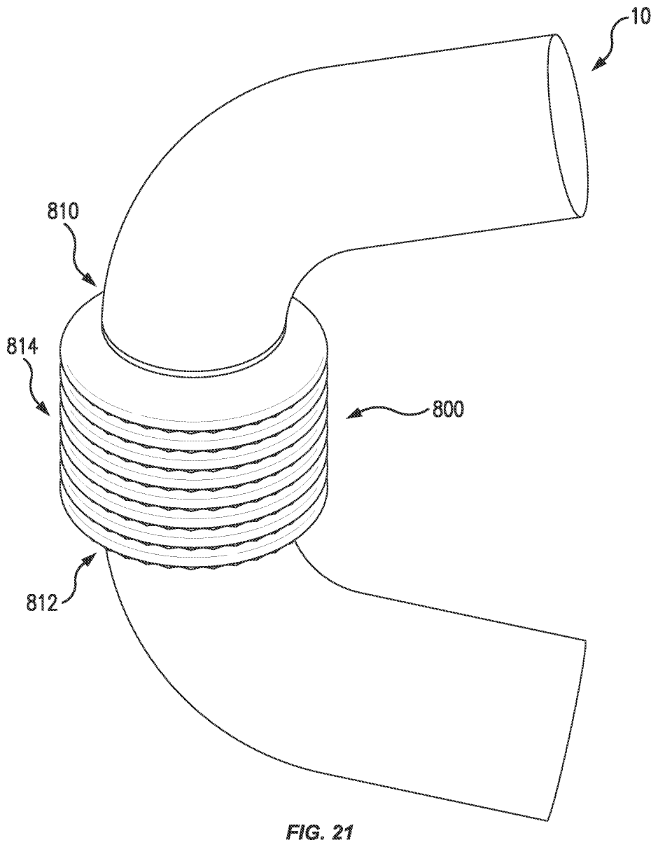

First connecting portion 810 extends around the longitudinal axis 824 to form a tube. Second connecting portion 812 extends around the longitudinal axis 824 to form a tube. In some embodiments, first and second connecting portions 810, 812 can be additively manufactured to have a different cross-sectional shape such as a square, oval, or other polygonal shape. In the illustrative embodiment in FIG. 21, first and second connecting portions 810, 812 can be integral with adjacent components and couple into a section of a system, propulsion device, or engine to transfer fluids (e.g. air, oxidizer, fuel, gas propellant, liquid propellant, other flow particles, or some combination thereof) therebetween. In some embodiments, first and second connecting portions 810, 812 can be coupled to an adjacent component, such as an exhaust duct, or fuel line, in propulsion device 10. In some embodiments, first and second connecting portions 810, 812 can be coupled to the adjacent component with a flange, or by welding, fusing, or other suitable coupling method.

Convolution 814 extends between first connecting portion 810 and second connecting portion 812 along longitudinal axis 824 as shown, for example in FIGS. 18 and 20. Convolution 814 is configured to be flexible such that first connecting portion 810 and second connecting portion 812 can move relative to one another. In the illustrative example if FIG. 20, convolution 814 can include first end 820, second end 822, first compliant portion 826, second compliant portion 828, third compliant portion 830, and fourth compliant portion 832. First end 820 connects to first connecting portion 810. Second end 822 connects to second connecting portion 812, or to a first end 820a of an adjacent convolution where bellows assembly 800 includes more than one convolution 814.

First compliant portion 826 extends outwardly away from first end 820 to form an inward cone shape. First compliant portion 826 extends at first angle 840 relative to a lateral axis 825, where the lateral axis 825 is perpendicular to longitudinal axis 824. First angle 840 can be between about 30 degrees to about 80 degrees relative to the lateral axis 825. Second compliant portion 828 extends from a distal end 842 of first compliant portion 826 and couples to a distal end 852 of third compliant portion 830. Third compliant portion 830 extends away from second compliant portion 828 toward second end 822 and forms an inward cone shape. Third compliant portion 830 extends at second angle 850 relative to the lateral axis 825. Second angle 850 can be between about 30 degrees to about 80 degrees relative to the lateral axis 825. In the illustrative embodiment shown in FIG. 20, first angle 840 is different from second angle 850. In some embodiments, first angle 840 is greater than second angle 850. In some embodiments, first angle 840 can be less than second angle 850. In some embodiments, first angle 840 and second angle 850 can be equal. Fourth compliant portion 832 extends between and couples second end 822 and proximal end 854 of third compliant portion 830 together.

In some embodiments, fourth compliant portion 832 can extend between third compliant portion 830 and second end 822 with a single smooth radius, as shown, for example, in FIG. 20. In some embodiments, fourth compliant portion 832 can have similar shape as fourth compliant portion 232′ of bellows assembly 200, or include a similar stiffening portion 270 as bellows assembly 200.

As illustratively shown in FIGS. 18-21, second compliant portion 828 can include a plurality of circumferentially spaced apart starting portions 860 to improve printing stability of convolution 814. Each starting portion 860 has a varying height 861 along the circumferential length of starting portion 860. The varying height 861 forms a wedge shape extending away from second compliant portion 828 with a maximum height 861 at a starting point 866 of starting portion 860. The resulting geometry triangular shaped starting portions 860 provide geometry that improves printability of convolution 814 and decreases the number of supporting members needed to initiate printing of the convolution shape. In some embodiments, a single support member can be used that aligns with each starting point 866. In some embodiments, starting portions 860 do not require any support members to start printing convolution 814.

As illustratively shown in FIG. 19, each starting portion 860 includes a first point 865, a starting point 866, a second point 867, a first side 862 extending between the first point 865 and the starting point 866, and a second side 864 extending between the starting point 866 and the second point 867. Starting portion 860 extends perpendicularly away from second compliant portion 828 approximately parallel with the longitudinal axis 824 with varying height 861. First side 862 extends circumferentially between first point 865 and starting point 866 at first slope angle 868 relative to lateral axis 825. Second side 864 extends circumferentially between second point 867 and starting point 866 at second slope angle 869 relative to lateral axis 825.

First slope angle 868 varies height 861 along the circumferential length of first side 862 such that first side 862 has maximum height 861 at starting point 866 and minimum height 861 at first point 865. Second slope angle 869 varies height 861 along the circumferential length of second side 864 such that second side 864 have maximum height 861 at starting point 866 and minimum height 861 at second point 867. First side 862 and second side 864 meet at starting point 866 which corresponds to the maximum height 861 of starting portion 860. In some embodiments, starting portion 860 blends into second compliant portion 828 at first point 865 and/or second point 867. In some embodiments, starting portion 860 maintains a minimum height 861 away from second complaint portion 828 at first and second points 865, 867 that corresponds to an intersection of adjacent starting portions 860, as illustratively shown in FIGS. 18 and 19.

In some embodiments, first slope angle 868 and second slope angle 869 are equal and approximately 20 degrees relative to lateral axis 825. Where first and second slope angles 868, 869 are equal, starting point 866 is approximately centered along the circumferential length of starting portion 860. In some embodiments, first and second slope angles 868, 869 are equal and between approximately 10 degrees and 50 degrees relative to lateral axis 825. In some embodiments, first and second slope angles 868, 869 are equal and between approximately 20 degrees and 30 degrees relative to lateral axis 825. In some embodiments, first slope angle 868 and second slope angle 869 are different. Where first and second slope angles 868, 869 are different, the circumferential lengths of first and second sides 862, 864 can be different, and starting point 866 can be positioned closer to one of first point 865 or second point 867.

In some embodiments, first and second sides 862, 864 have linear extending sides. In some embodiments, first and second sides 862, 864 are curved with varying slope angle 868, 869 along the circumferential length. In some embodiment, adjacent starting portions 860 circumferentially overlap. In some embodiments, a first point 865 of a first starting portion 860 is circumferentially spaced apart from a second point 867 of a second starting portion 860.

### Example Bellows Assembly with Circumferential Supports

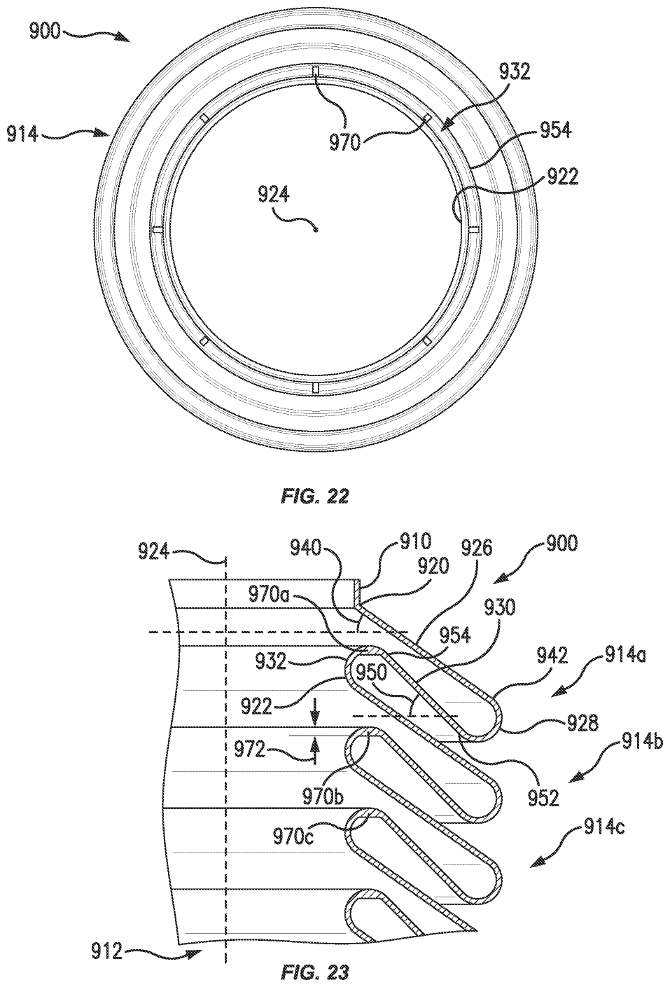

FIGS. 22-24 provide another embodiment of a bellows assembly 900 in accordance with the present disclosure and show a different convolution 914 configuration. Bellows assembly 900 is substantially similar to bellows assembly 200 shown in FIGS. 6-8 and described herein. Accordingly, similar reference numbers in the 900 series indicate commonalities between bellows assembly 900 and bellows assembly 200. The description of bellows assembly 200 above is incorporated by reference to apply to bellows assembly 900, except in instances when it conflicts with the specific description and the drawings of bellows assembly 900.

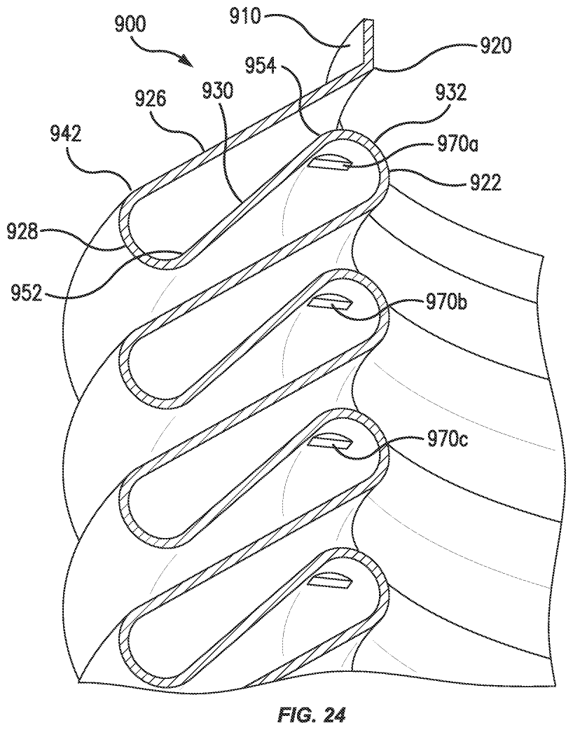

Bellows assembly 900 includes first connecting portion 910, second connecting portion 912, and at least one convolution 914. As shown in FIGS. 23 and 24, for example, bellows assembly 900 can include more than four convolutions 914 with similar geometries stacked on top of each other along a longitudinal axis 924, but more or fewer convolutions 914 can also be possible.

Convolution 914 extends between first connecting portion 910 and second connecting portion 912 along longitudinal axis 924 as shown, for example in FIG. 23. Convolution 914 can include first end 920, second end 922, first compliant portion 926, second compliant portion 928, third compliant portion 930, fourth compliant portion 932, and support 970. First compliant portion 926 extends outwardly away from first end 920 to form an inward cone shape. First compliant portion 926 extends at first angle 940 relative to a lateral axis 925. Second compliant portion 928 extends from a distal end 942 of first compliant portion 926 and couples to a distal end 952 of third compliant portion 930. Third compliant portion 930 extends away from second compliant portion 928 toward second end 922 and forms an inward cone shape. Third compliant portion 930 extends at second angle 950 relative to the lateral axis 925. Fourth compliant portion 932 extends between and couples second end 922 and proximal end 954 of third compliant portion 930 together.

As illustratively shown in FIGS. 22-24, convolution 914 includes a plurality of circumferentially spaced apart supports 970 around fourth compliant portion 932 relative to the longitudinal axis 924. Support 970 extends across the inner radius of fourth compliant portion 932 to provide an additional layer of material that supports fourth compliant portion 932 during printing and manufacture. During manufacture of bellows assembly 900, a gap forms in fourth compliant portion 932 between second end 922 and proximal end 954 of third compliant portion 930 as shown, for example, in FIG. 22. Supports 970 bridge across the gap to maintain concentricity and shape of convolution 914 and fourth compliant portion 932.

Each support 970 extends across an inner radius of fourth compliant portion 932 that may be vulnerable to warping during manufacture as shown, for example, in FIGS. 23 and 24. Each support 970 extends radially across fourth compliant portion 932 and approximately parallel to the lateral axis 225. Support 970 extends a small distance circumferentially to provide support during manufacture without adding excess weight to bellows assembly 900. Support 970 has height 972 approximately parallel to the longitudinal axis. In some embodiments, support 970 has height 972 that extends beyond proximal end 954 of third compliant portion 930 such that support 970 is integral with third compliant portion 930.

Supports 970 are equally spaced apart around fourth compliant portion 932. Equal circumferential spacing of supports 970 provide convolution 914 with even support and allows tight tolerances to be maintained of bellows assembly 900. In illustrative embodiment in FIG. 22, convolution 914 includes eight supports 970 equally spaced apart by approximately 45 degrees. In some embodiments, convolution 914 can include four supports equally spaced apart by approximately 90 degrees. In some embodiments, convolution 914 can include six supports equally spaced apart by approximately 30 degrees. In some embodiments, convolution 914 can include any number of supports greater than two that are equally spaced apart. Generally, as the diameter of bellows assembly 900 increases, more supports 970 may be included to provide additional support during manufacture. In the illustrative embodiment in FIGS. 23 and 24, supports 970a, 970b, 970c are aligned between adjacent convolutions 914a, 914b, 914c, such that support 970a in convolution 914a is positioned above support 970b in convolution 914b. In some embodiments, supports 970 can be offset between adjacent convolutions 914. For example, in a first convolution 914, four supports 970 maybe be positioned at 0, 90, 180, and 270 degrees, and in a second adjacent convolution 914, four supports 970 maybe be positioned at 45, 135, 225, and 315 degrees.

### Example Spiral Bellows Assembly with Radial and Circumferential Overlaps

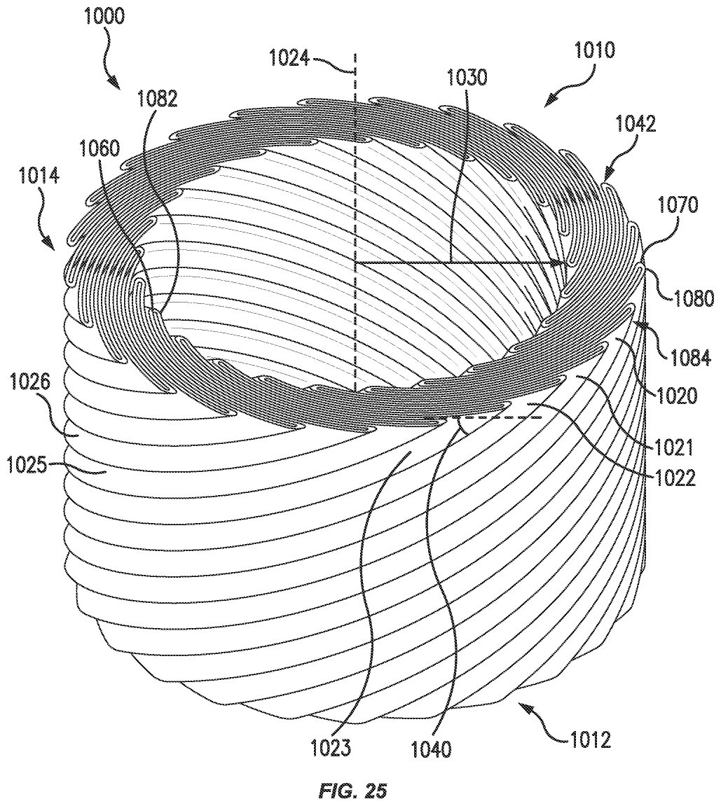

Another embodiment of a bellows assembly 1000 in accordance with the present disclosure is shown in FIGS. 25-27 showing a different helix convolution 1014 configuration. Bellows assembly 100 is substantially similar to bellows assembly 500 shown in FIGS. 12 and 13 and described herein. Accordingly, similar reference numbers in the 1000 series indicate commonalities between bellows assembly 1000 and bellows assembly 500. The description of bellows assembly 500 is incorporated by reference to apply to bellows assembly 1000, except in instances when it conflicts with the specific description and the drawings of bellows assembly 1000.

FIGS. 25-27 illustrate bellows assembly 1000, according to embodiments. Bellows assembly 1000 includes first connecting portion 1010 (not shown), second connecting portion 1012 (not shown), and helix convolution 1014. Helix convolution 1014 can include more than twenty individual adjoining and overlapping convolutions. In some embodiments, helix convolution 1014 can include less than twenty individual adjoining convolutions. Each of the adjoining and overlapping convolutions 1020, 1021, 1022, 1023, 1025, 1026 are circumferentially and radially spaced apart and parallel to one another. The adjoining and overlapping convolutions 1020, 1021, 1022, 1023, 1025, 1026 extend between the first and second connecting portions 1010, 1012 along longitudinal axis 1024 to form the helix shape. In some embodiments, bellows assembly 1000 is additively manufactured.

First connecting portion 1010 (not shown) can extend around the longitudinal axis 1024 to form a tube. Second connecting portion 1012 (not shown) can extend around the longitudinal axis 1024 to form a tube. Helix convolution 1014 extends between first connecting portion 1010 and second connecting portion 1012 along longitudinal axis 1024. Helix convolution 1014 can have a wall thickness between about 0.3 mm and 5 mm. In some embodiments, helix convolution 1014 can have a wall thickness of about 0.5 mm. Helix convolution 1014 can be configured to be flexible such that first connecting portion 1010 and second connecting portion 1012 can move relative to one another.

Helix convolution 1014 can include a plurality of individual helixes circumferentially and radially spaced apart and extending around longitudinal axis 1024, parallel to one another as shown for example in FIGS. 25-27. A first helix 1020 of the plurality of helixes can have similar geometry to adjacent helixes 1021, 1022, 1023, 1025, 1026 of the plurality of individual helixes. In some embodiments, the number of helixes in helix convolution 1014 can be constrained by a radius 1030 of the bellows assembly 1000. For example, as radius 1030 of helix convolution 1014 increases, the number of helixes arranged around the circumference of helix convolution 1014 can also increase. Alternatively, as radius 1030 of helix convolution 1014 decreases, the number of helixes that can be arranged around the circumference of helix convolution 1014 can also decrease. In some embodiments, the number of helixes in helix convolution 1014 can be a function of the desired flexibility of bellows assembly 1000.

In some embodiments, inner radius 1030 of bellows assembly 1000 can be between about 10 mm and about 500 mm. In some embodiments, the outer radius of bellows assembly 100 can be between about 25 mm and about 600 mm. In some embodiments, the height of bellows assembly 1000 along longitudinal axis 1024 can be about 10 mm to about 500 mm. In some embodiments, first helix 1020, and adjacent helixes 1021, 1022, 1023, 1025, 1026, can have wall thickness between about 0.4 mm and about 2 mm.

First helix 1020 is spaced apart from the longitudinal axis 1024 by radius 1030 and extends circumferentially around longitudinal axis 1024 as shown, for example, in FIGS. 25-27. As first helix 1020 extends circumferentially around longitudinal axis 1024, first helix 1020 increases in height along longitudinal axis 1024 such that first helix 1020 extends circumferentially at a first circumferential angle 1040 relative to plane 1042. First helix 1020 also leans radially inward toward the center of bellows assembly 1000 at a second radial angle 1050 relative to plane 1042 as first helix 1020 increases in height. Plane 1042 is perpendicular to longitudinal axis 1024. The inventors realized and discovered that the second radial angle 1050 provided helix 1014 with similar properties to an inward cone shape and associated hoop stresses allowing for a stable additive manufacturing process of bellows assembly 1000.

In some embodiments, first circumferential angle 1040 can be between about 10 degrees and about 45 degrees. In some embodiments, first circumferential angle 1040 can be between about 15 degrees and about 35 degrees. In the illustrative embodiment shown in FIG. 25, first circumferential angle 1040 is consistent along the length of helix convolution 1014 and about 30 degrees relative to plane 1042. In some embodiments, second radial angle 1050 can be between about 15 degrees and about 60 degrees. In the illustrative embodiment shown in FIG. 27, second radial angle 1050 is about 60 degrees relative to plane 1042. The inventors realized and discovered that using the circumferential and radial angles 1040, 1050 would increase printing stability and manufacturing yield of bellows assembly 1000, and avoid melt-pool instability.

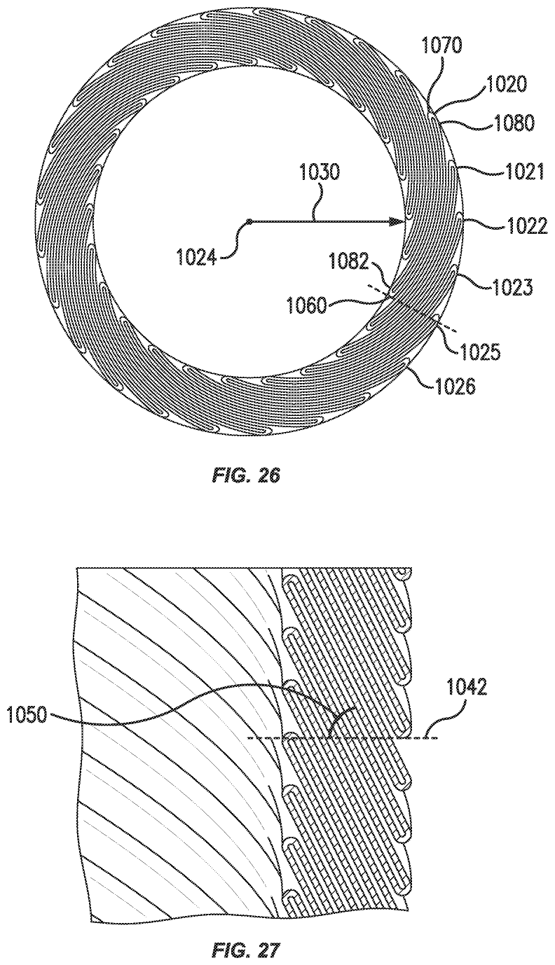

As shown, for example, in FIG. 26, first helix 1020 has a cross-section parallel to plane 1042 that includes a concave portion 1060 and a convex portion 1070. Each of adjacent helixes 1021, 1022, 1023, 1025, 1026, of helix convolution 1014 have similar cross-sectional shape to first helix 1020. Convex portion 1070 extends from an outer radius portion 1080 of helix convolution 1014 inward toward concave portion 1060. Convex portion 1070 is at an overhang portion of first helix 1020. Concave portion 1060 extends inwardly away from convex portion 1070 with opposite curvature to convex portion 1070 and toward inner radius portion 1082. In some embodiments, concave portion 1060 can have an inner radius of about 0.2 mm to 3 mm. In some embodiments, concave portion 1060 can have an inner radius of about 0.2 mm to 50 mm. The inventors realized and discovered that using smaller local radii of convex portion 1070 or increased first angle 1040 of first helix 1020 would increase printing stability and manufacturing yield of bellows assembly 1000, and to avoid melt-pool instability in the overhang portion.

First helix 1020 overlaps multiple adjacent helixes throughout bellows assembly 1000 and provides an overlap gap 1032 between adjacent helixes. In some embodiments, overlap gap 1032 is between about 0.4 mm and 5 mm. In the illustrative embodiment in FIG. 26, first helix 1020 radially overlaps with adjacent helixes 1021, 1022, 1023, 1025, such that concave portion 1060 of first helix 1020 circumferentially overlaps with a convex portion 1070′ of helix 1025. In the illustrative embodiment in FIGS. 25-27, bellows assembly 1000 contains at least four overlapping helixes through any radial cross-section.

### Example Dual Direction Spiral Bellows Assembly

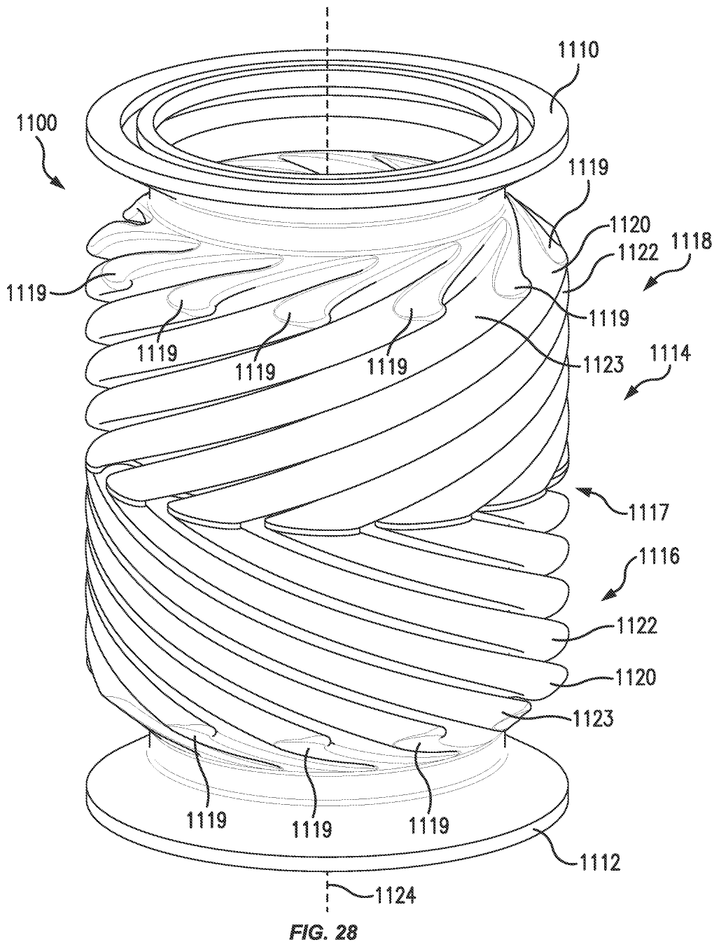

Another embodiment of a bellows assembly 1100 in accordance with the present disclosure is shown in FIGS. 28-31 showing a different dual direction helix convolution 1114 configuration. Bellows assembly 1100 is substantially similar to bellows assembly 500 shown in FIGS. 12 and 13 and described herein. Accordingly, similar reference numbers in the 1100 series indicate commonalities between bellows assembly 1100 and bellows assembly 500. The description of bellows assembly 500 is incorporated by reference to apply to bellows assembly 1100, except in instances when it conflicts with the specific description and the drawings of bellows assembly 1100.

FIGS. 28-31 illustrate bellows assembly 1100, according to embodiments. Bellows assembly 1100 can be coupled to adjacent components in propulsion device 10. Bellows assembly 1100 includes first connecting portion 1110, second connecting portion 1112, and helix convolution 1114. Helix convolution 1114 can include first helix portion 1116, second helix portion 1118, transition portion 1117 between first helix portion 1116 and second helix portion 1118, and helix caps 1119. Helix convolution 1114 can include between about four and twelve individual adjoining convolutions, circumferentially spaced apart and parallel to one another, and extending between the first and second connecting portions 1110, 1112 to form the helix shape. In the illustrative example in FIG. 28, each of the individual adjoining convolutions 1120, 1122, 1123 rotate in a clockwise direction in the first helix portion 1116 as they translate upward from second connecting portion 1112, before transitioning and then rotating counterclockwise in the second helix portion 1118 toward first connecting portion 1110. In some embodiments, the individual adjoining convolutions 1120, 1122, 1123 can rotate in a counter-clockwise direction in the first helix portion 1116 and a clockwise direction in the second helix portion 1118. In some embodiments, bellows assembly 1100 is additively manufactured.

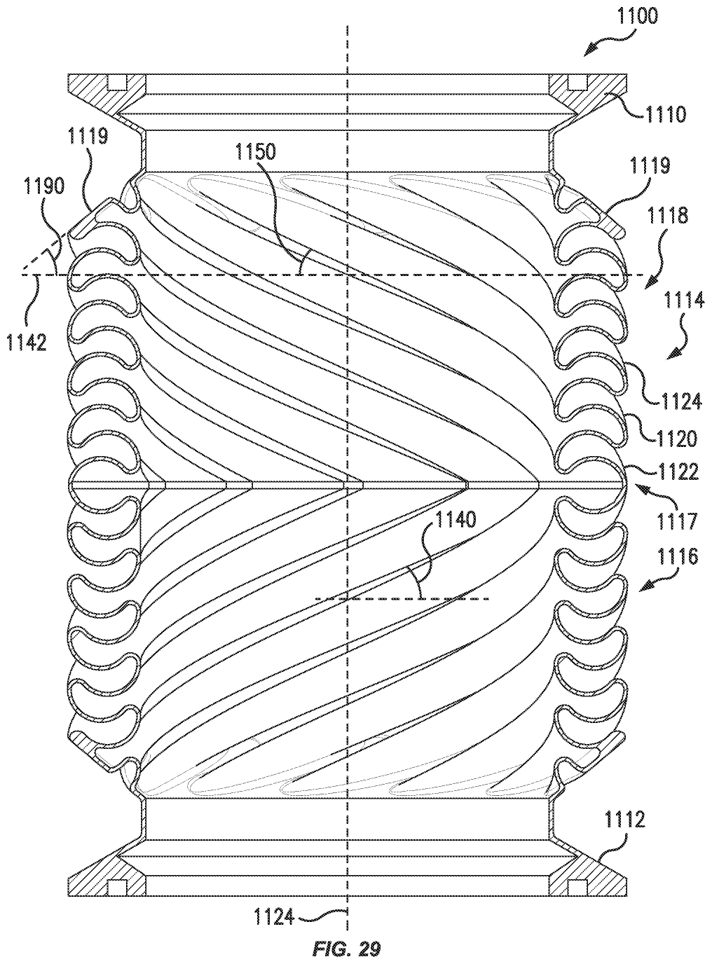

In the illustrative example in FIGS. 28 and 29, first connecting portion 1110 extends around the longitudinal axis 1124 to form a tube and flange. First connecting portion 1110 can be coupled to an adjacent component, such as an exhaust duct, or fuel line, in propulsion device 10 via the flange portion. In some embodiments, first connecting portion 1110 can be coupled to the adjacent component by welding, fusing, or other suitable coupling method. In some embodiments, first connecting portion 1110 can be integral with the adjacent component to reduce overall part count in the propulsion device 10 such as shown in bellows assembly 800 described above.

Second connecting portion 1112 can extend around the longitudinal axis 1124 to form a tube and flange as shown, for example in FIGS. 28 and 29. Second connecting portion 1112 can be coupled to an adjacent component, such as an exhaust duct, or fuel line, in propulsion device 10 via the flange portion. In some embodiments, second connecting portion 1112 can be coupled to the adjacent component by welding, fusing, or other suitable coupling method. In some embodiments, second connecting portion 1112 can be integral with the adjacent component to reduce overall part count in the propulsion device 10 such as shown in bellows assembly 800 described above.

Helix convolution 1114 extends between first connecting portion 1110 and second connecting portion 1112 along longitudinal axis 1124. Helix convolution 1114 can be configured to be flexible such that first connecting portion 1110 and second connecting portion 1112 can move relative to one another. In some embodiments, convolution 1114 allows for torsional angular rotation of first connecting portion 1110 relative to second connecting portion 1112 such that bellows assembly 1100 provides a torsional angular compliance between adjacent component of the propulsion device 10. In some embodiments, transition portion 1117 can be positioned equidistant between first connecting portion 1110 and second connecting portion 1112 such that first helix portion 1116 and second helix portion 1118 have approximately equal lengths along longitudinal axis 1124. Where first helix portion 1116 and second helix portion 1118 have similar geometries and equal lengths, torsional angular compliance can be reduced in bellows assembly 1110 since torsion produced by movement of the helix portions 1116, 1118 can be canceled out. In some embodiments, the position of the transition portion 1117 can be moved closer to one of the first connecting portion 1110 or second connecting portion 1112 resulting unequal lengths of first helix portion 1116 and second helix portion 1118. Unequal lengths of the relative helix portions 1116, 1118 may allow torsional angular compliance in a selected direction. In some embodiments, transition portion 1117 has a height parallel with the longitudinal axis 1124 between about 0 mm and about 10 mm. In some embodiments, transition portion 1117 has a height parallel with the longitudinal axis 1124 between about 0 mm and 50 mm. In some embodiments, transition portion 1117 has a height parallel with the longitudinal axis 1124 greater than 50 mm.

Helix convolution 1114 can include a plurality of individual helixes circumferentially spaced apart and extending around longitudinal axis 1124 parallel to one another as shown for example in FIGS. 28-31. A first helix 1120 of the plurality of helixes can have similar geometry to adjacent helixes 1122, 1123 of the plurality of individual helixes. First helix 1120 is spaced apart from the longitudinal axis 1124 by radius 1130 and extends circumferentially around longitudinal axis 1124 in a first direction in the first helix portion 1116 and in a second direction, opposite the first direction, in the second helix portion 1118 as shown, for example, in FIGS. 28 and 29. In the illustrative embodiment in FIGS. 28 and 29, the first direction is clockwise and the second direction is counter-clockwise. In some embodiments, the first direction is counter-clockwise and the second direction is clockwise.

As first helix 1120 extends circumferentially around longitudinal axis 1124 in first helix portion 1116, first helix 1120 increases in height along longitudinal axis 1124 such that first helix 1120 extends at a first angle 1140 relative to plane 1142. Plane 1142 is perpendicular to longitudinal axis 1124. In the transition portion 1117, first helix 1120 extends approximately parallel with longitudinal axis 1124. As first helix 1120 extends circumferentially around longitudinal axis 1124 in second helix portion 1118, first helix 1120 increases in height along longitudinal axis 1124 such that first helix 1120 extends at a second angle 1150 relative to plane 1142.

In some embodiments, first angle 1140 and second angle 1150 can be acute angles relative to plane 1142 between about 10 degrees and about 30 degrees relative to plane 1142. In an alternate embodiment, the first angle is an acute angle about 30 degrees and the second angle is an obtuse angle about 150 degrees relative to the same side of helix 1120. In some embodiments, first angle 1140 and second angle 1150 can be between about 30 degrees and about 60 degrees relative to plane 1042. In the illustrative embodiment in FIG. 28, first angle 1140 is constant along the length of first helix portion 1116 and second angle 1150 is constant along the length of second helix portion 1118. In some embodiments, first angle 1140 and second angle 1150 can be different such that the respective flexibility and/or torsional properties in the first helix portion 1116 and the second helix portion 1118 can differ.

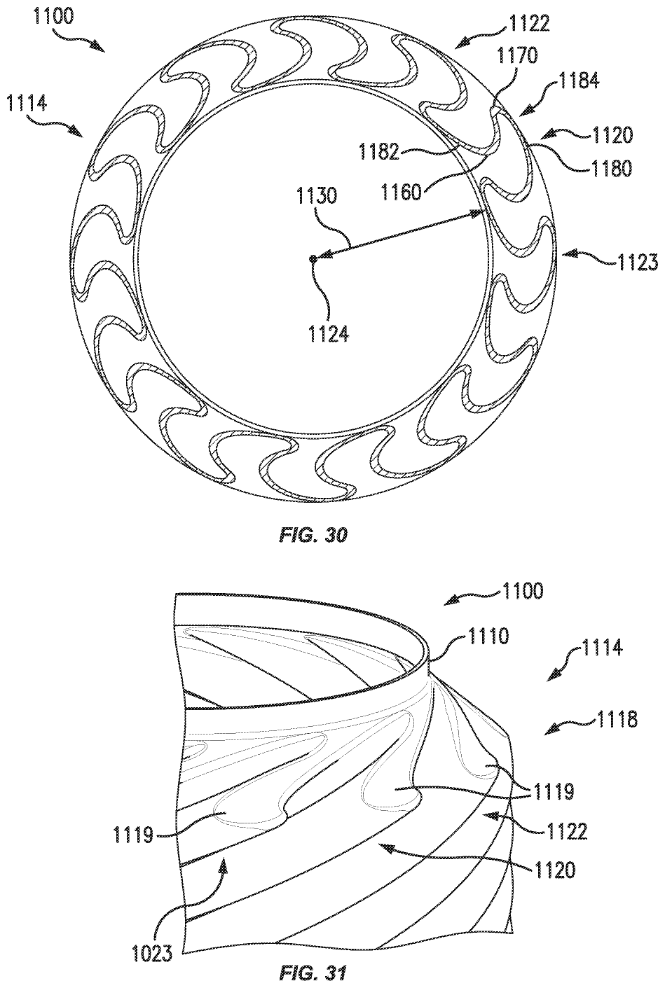

As shown, for example, in FIG. 30, first helix 1120 has a cross-section parallel to plane 1142 that includes a concave portion 1160 and a convex portion 1170. Each of adjacent helixes 1122, 1123, of helix convolution 1114 have similar cross-sectional shape to first helix 1120. Convex portion 1170 extends from an outer radius portion 1180 of helix convolution 1114 inward toward concave portion 1160. Convex portion 1170 is at an overhang portion 1184 of first helix 1120. The inventors realized and discovered that using smaller local radii of convex portion 1170 or increased first angle 1140 of first helix 1120 would increase printing stability and manufacturing yield of bellows assembly 1100, and to avoid melt-pool instability in overhang portion 1184. Concave portion 1160 extends inwardly away from convex portion 1170 with opposite curvature to convex portion 1170 and toward inner radius portion 1182. Concave portion 1160 can have larger radius than convex portion 1170 while maintaining high printing stability during additive manufacturing. Concave portion 1160 is supported by inner radius portion 1182 and convex portion 1170 and can have more stable printing properties than convex portion 1170.

The cross section of helix convolution 1114 can minimize the curvature or radius of the convex portion 1170 of outcropping section 1184 of the bellows assembly 1100. The reduced curvature can decrease warp up, material shape changes caused by heat, or decrease printing instability of convex portion 1170. As such, first and second angles 1140, 1150 of approximately 20 degrees, can be used for convex portion 1170 to print smooth overhangs 1184 without the need for supports.

Bellows assembly 1100 includes helix caps 1119 that seal the top and bottom of the helix convolution 1114 at the transition between helix convolution 1114 and the first and second connecting portions 1110, 1112. Helix caps 1119 seal the bellows assembly 1100 to maintain pressure of the fluid within the bellows assembly 1100 and/or propulsion device 10 as required, and to avoid leaking any fluids from the bellows assembly 1100 at a coupling location to an adjacent component in the system. Similar helix caps 1119 can be applied to any of bellows assemblies 500, 600, 1000, 1200.

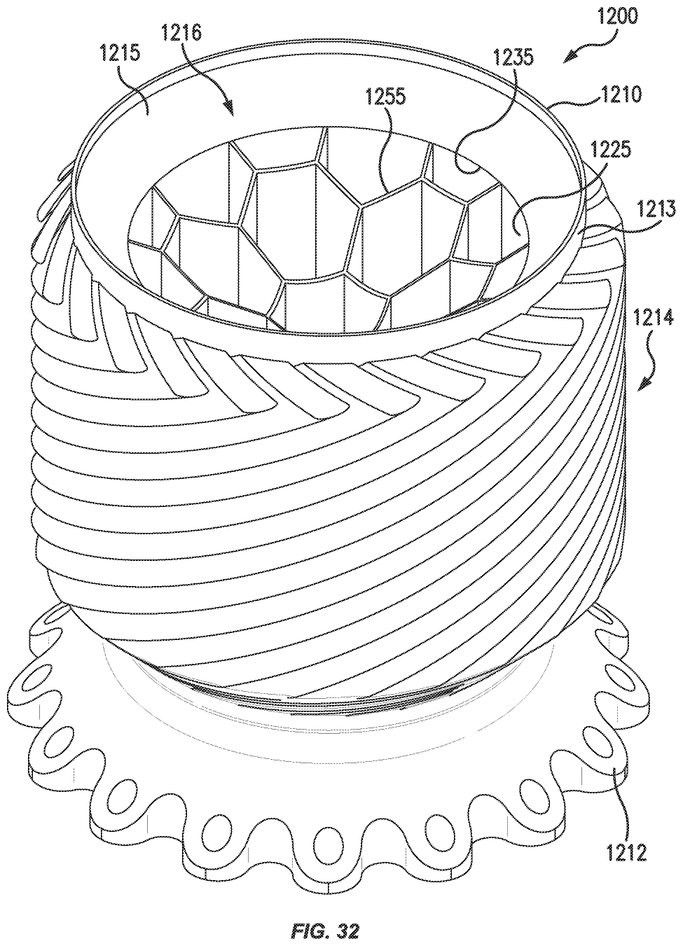

Each helix 1120, 1122, 1123 includes a helix cap 1119 at the top and bottom of helix convolution 1114 as shown, for example, in FIGS. 28 and 31. Each helix cap 1119 blends into the top of each helix 1120, 1122, 1123 to form a convex surface. Helix caps 1119 are formed at a cap angle 1190 relative to plane 1142. In some embodiments, cap angle 1190 is between about 10 degrees and 60 degrees relative to plane 1142. In some embodiments, cap angle is about 30 degrees relative to plane 1142. The inventors realized and discovered that angling the helix caps 1119 at cap angle 1190 would increase printing stability and manufacturing yield of bellows assembly 1100, and provide geometry that did not need additional supports during manufacture. The inventors also realized and discovered that angling the helix caps 1119 at cap angle 1190 would increase the flexibility of the bellows assembly 1100 in the transition between helix convolution 1114 and first and second connecting portions 1110, 1112. In addition, cap angle 1190 provides additional clearance between helix convolution 1114 and the flanges of first and second connecting portions 1110, 1112 for assembly features such as bolts or tools to allow for tightening of flange bolts.

### Example Bellows Flow Conditioner

Another embodiment of a bellows assembly 1200 in accordance with the present disclosure is shown in FIGS. 32-35 showing a bellows flow conditioner 1216. Bellows assembly 1200 is substantially similar to bellows assembly 1000 shown in FIGS. 25-27 and described herein. Accordingly, similar reference numbers in the 1200 series indicate commonalities between bellows assembly 1200 and bellows assembly 1000. The description of bellows assembly 1000 is incorporated by reference to apply to bellows assembly 1200, except in instances when it conflicts with the specific description and the drawings of bellows assembly 1200. Flow conditioner 1216 can also be used in any of the bellows assemblies 100, 200, 300, 400, 500, 600, 800, 900, 1000, 1100 described herein.

FIGS. 32-35 illustrate bellows assembly 1200, according to embodiments. Bellows assembly 1200 can be coupled to adjacent components in propulsion device 10. Bellows assembly 1200 includes first connecting portion 1210, second connecting portion 1212, convolution 1214, and flow conditioner 1216. Flow conditioner 1216 can control the flow of gas or fluid passing through bellows assembly 1200. Flow conditioner 1216 includes a plurality of baffles 1255 configured to limit and/or reduce turbulence in the gas or fluid flowing through bellows assembly 1200. In some embodiments, bends and turns in components that are adjacent or connected to bellows assembly 1200 may introduce swirl and/or turbulence into the gas or fluid flowing through the system. The plurality of baffles 1255 can control and smooth the flow to reduce turbulence. In some embodiments, a bellows assembly, such as bellows assembly 1000, includes a helix convolution 1014 that can introduce swirl to the fluid flowing through the bellows assembly due to the geometry of the exposed helix convolution 1014 on the inside of the bellows assembly. In the illustrative embodiment in FIGS. 32-35, the convolution 1214 can be covered by flow conditioner 1216 such that the shape of the convolution 1214 does not affect the fluid flowing through the flow conditioner 1216.

First connecting portion 1210 can extend around the longitudinal axis 1224 to form a tube. First connecting portion 1210 can be coupled to an adjacent component, such as an exhaust duct, or fuel line, in propulsion device 10. In some embodiments, first connecting portion 1210 can be coupled to the adjacent component with a flange, or by welding, fusing, or other suitable coupling method. In some embodiments, first connecting portion 1210 can be integral with the adjacent component to reduce overall part count in the propulsion device 10.

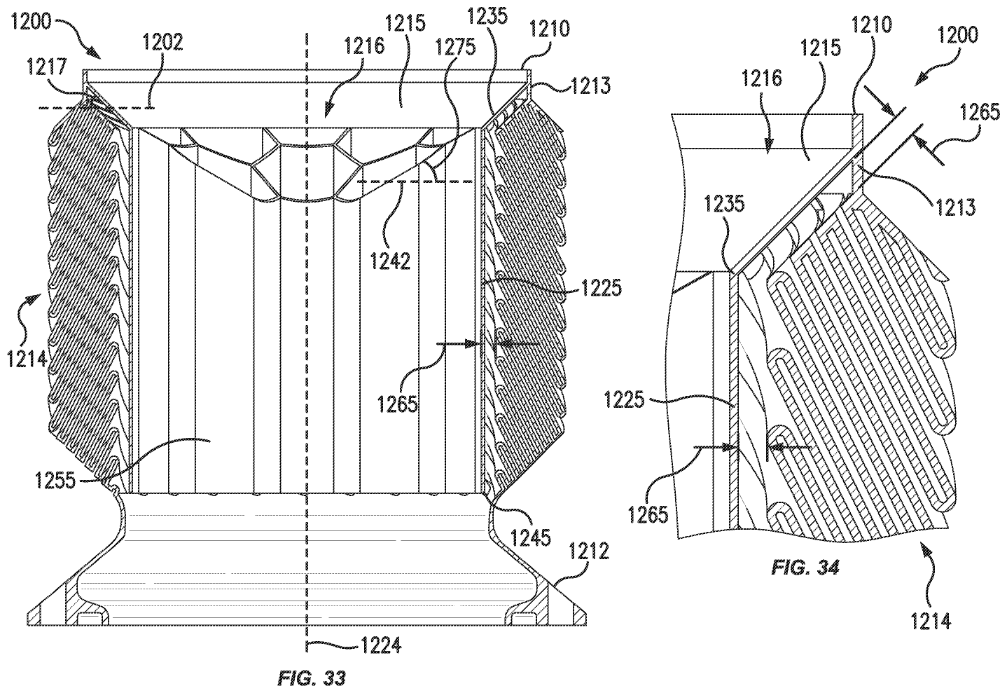

Second connecting portion 1212 can extend around the longitudinal axis 1224 to form a tube with a flange. In the illustrative embodiment in FIGS. 32 and 33, second connecting portion 1212 includes a flange with a plurality of apertures circumferentially spaced around the flange. The plurality of apertures can be configured to receive bolts therethrough that can be used to couple bellows assembly 1200 to an adjacent component in the system. Second connecting portion 1212 can be coupled to an adjacent component, such as an exhaust duct, or fuel line, in propulsion device 10. In some embodiments, second connecting portion 1212 can be coupled to the adjacent component by welding, fusing, or other suitable coupling method. In some embodiments, second connecting portion 1212 can be integral with the adjacent component to reduce overall part count in the propulsion device 10.

Flow conditioner 1216 couples to first tube portion 1213 that extends between first connection portion 1210 and convolution 1214. Flow conditioner 1216 extends inward of convolution 1214 and approximately parallel to the longitudinal axis 1224 along the length of convolution 1214 as shown, for example, in FIG. 33. Flow conditioner 1216 couples to only one end of the bellows assembly 1200 and is configured to be free at the non-coupled end such that as convolution 1214 expands or contracts, flow conditioner 1216 is fixed with the first connecting portion 1210 and moves relative to second connecting portion 1212. This allows the second connecting portion 1212 to move relative to first connecting portion 1210, but maintains positioning of flow conditioner 1216 inside the bellows to control and smooth the fluid flow therebetween.

Flow conditioner 1216 includes inlet cone 1215 and conditioner body 1225 as shown, for example, in FIGS. 32-34. Inlet cone 1215 can be integrated with first connecting portion 1210 and extends radially inward and toward convolution 1214 to form an inward cone at the entry of the flow conditioner 1216 and bellows assembly 1200. Inlet cone 1215 extends at a cone angle 1217 between about 10 degrees and 60 degrees relative to plane 1242. Plane 1242 is perpendicular to longitudinal axis 1224. In some embodiments, cone angle 1217 is between about 15 degrees and 45 degrees. Cone angle 1217 improves printing stability and increases manufacturing yield of inlet cone 1215 and bellows assembly 1200. Inlet cone 1215 directs fluid flowing into the bellows assembly 1200, via first connecting portion 1210, into the flow conditioner 1216. Conditioner body 1225 includes a fixed end 1235 integrated with and extending from to the inlet cone 1215, and a free end 1245 adjacent to second connecting portion 1212. Conditioner body 1225 extends circumferentially around longitudinal axis 1224 and extends away from inlet cone 1215 approximately parallel to longitudinal axis 1224. During operation, flow conditioner 1216 is fixed and moves with first connecting portion 1210, such that free end 1245 of conditioner body 1225 of flow conditioner 1216 moves relative to second connecting portion 1212.

Inlet cone 1215 and conditioner body 1225 maintain a gap 1265 with an interior shape of convolution 1214 as shown, for example, in FIG. 33-35. In some embodiments, gap 1265 can be reduced where the relative movement between first and second connecting portions 1210, 1212 is one of expansion or contraction along the longitudinal axis 1224, or one of pure rotational movement or torsion. For example, for said movement, gap 1265 can be maintained between about 0.5 mm and 2.5 mm. In some embodiments, gap 1265 can be increased where relative movement between first and second connecting portions 1210, 1212 is one of radial movement perpendicular to the longitudinal axis 1224, or angular rotation and compliance such that bellows assembly 1200 can gimbal or tilt by an angle relative to longitudinal axis 1224. For example, for said angular movements, gap 1265 can be greater than 2.5 mm. In some embodiments, gap 1265 can be increased or decreased based on the expected movements of the bellows assembly 1200 in the particular application.

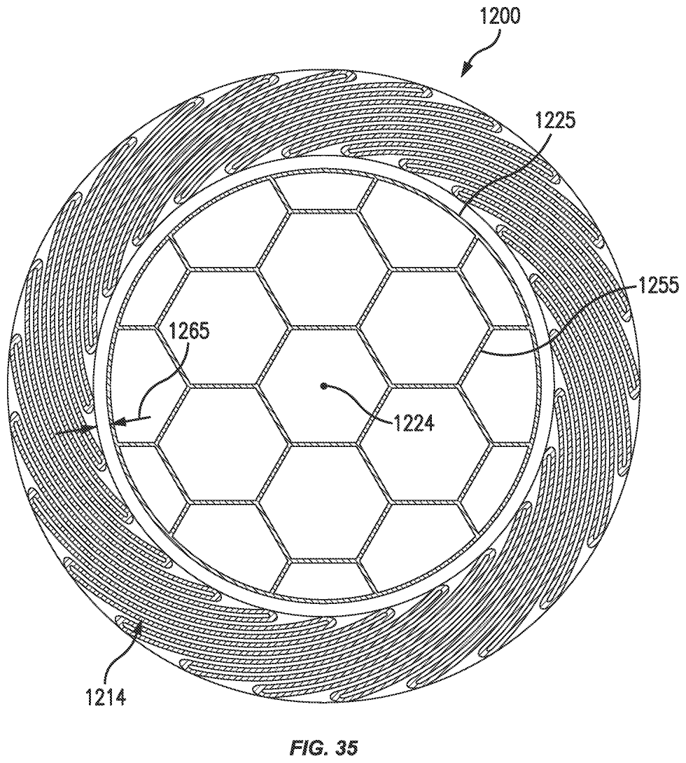

Flow conditioner 1216 includes a plurality of baffles 1255 that divide the cross-sectional area of conditioner body 1225 into smaller channels, as shown, for example, in FIGS. 32, 33, and 35. In some embodiments, conditioner body 1225 can be an empty cylinder configured to translate fluid through bellows assembly 1200 while limiting the fluids contact with convolution 1214. In the illustrative embodiment in FIG. 35, the plurality of baffles 1255 have hexagonal shape and extend through the conditioner body 1225 parallel to longitudinal axis 1224. In some embodiments, the plurality of baffles 1255 can have any shape including squares, triangles, ovals, circles, or other polygonal shapes. In some embodiments, the plurality of baffles 1225 can have a helix configuration to introduce a swirl condition into the fluid flowing therebetween.

A recess is formed in the top surface of the plurality of baffles 1255 at the coupled end 1235 of the conditioner body 1225 as shown, for example, in FIG. 33. The formed recess has a baffle angle 1275. Baffle angle 1275 increases printing stability of the top portion of the plurality of baffles 1255 by introducing an angled surface for additive manufacture. The inventors discovered and realized that a recess with baffle angle 1275 in the top of the plurality of baffles 1255 increased manufacturing yield of the flow conditioner and improved capture of the fluid flow entering the flow conditioner 1216. In some embodiments, the baffle angle 1275 is similar to the cone angle 1217 of the inlet cone. In some embodiments, the baffle angle 1275 is between about 10 degrees and 60 degrees. In some embodiments, the baffle angle 1275 is between about 15 degrees and 45 degrees. Bellows assembly 1200 can be additively manufactured. In the illustrative example in FIG. 33, additive manufacturing of bellows assembly 1200 starts with the second connecting portion 1212 and forms the bellows assembly 1200 and corresponding features 1245, 1255, 1225, 1235, 1265, 1214, 1215, 1210 from the bottom of the FIG. 33 and builds upward. Flow conditioner 1216 can have a wall thickness between about 0.3 mm and 5 mm. In some embodiments, flow conditioner can have a wall thickness of about 0.5 mm.

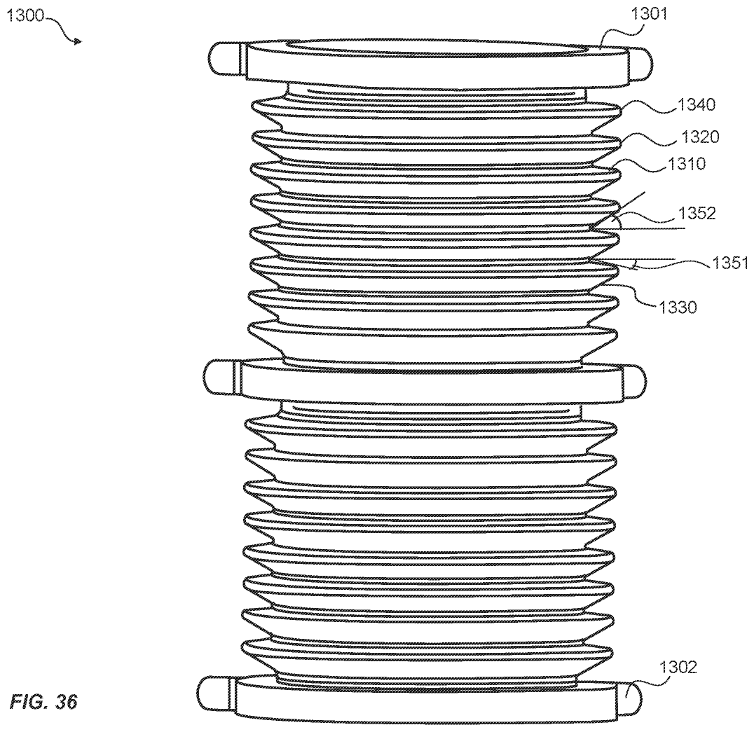

FIG. 36 illustrates a thirteenth bellows configuration, according to an embodiment of the present disclosure. Similar to the bellows of other embodiments, a bellows 1300 may comprise a first connecting portion 1301 at a first end of the bellows, a second connecting portion 1302 at a second end of the bellows opposite the first end along a longitudinal axis of the bellows, and a plurality of convolutions located between the first connecting portion 1301 and the second connection portion 1302. The plurality of convolutions may comprise first compliant portions 1310 having an angled shape and second compliant portions 1320 having a substantially arcuate shape. The plurality of convolutions may further comprise third compliant portions 1330 have an angled shape. In an embodiment shown, the first compliant portions 1310 may form an inward cone shape at a relatively flat or narrow angle, and the third compliant portions 1330 may extend outwardly at a relatively steep or wide angle. The first compliant portions 1310 may extend outwardly at a first angle 1351 between 15 degrees to 45 degrees relative to a lateral axis of the bellows 1300, and the third compliant portions may extend outwardly at a second angle 1352 between 30 degrees to 45 degrees relative to the lateral axis of the bellows 1300. In some embodiments, such as shown in FIG. 36, the first angle 1351 is substantially narrower than the second angle 1352. In some embodiments, the first angle 1351 and the second angle 1352 are substantially equal. The second compliant portions 1320 having the substantially arcuate shape connect the first compliant portions 1310 and the third compliant portion 1330, such as by forming a fillet having a fillet radius 1340. In an embodiment shown in FIG. 36, the second compliant portions may have a fillet radius 1340 of about 0.5 mm.

### Additional Embodiments

Bellows have applications anywhere fluid systems exist, such as mining, fracking, oil and gas recovery, and so forth. Bellows also have application outside of fluid systems, for example, as highly customized springs in a purely structural/mechanical use. Examples of such purely structure/mechanical uses include vehicle suspensions, hydraulic and pneumatic spring return mechanisms, or basically anywhere a spring would also fit the application. Accordingly, it should be understood that while some embodiments include propulsion devices and connections to and within propulsion devices, the invention itself is not so limited. The embodiments described above are contemplated for use with such fluid systems and structural/mechanical systems. For example, in some applications, the bellows of the present invention can provide a fully sealed joint to transfer liquids and/or gases between adjacent engine components. In some applications, the bellows of the present invention can be applied in flexure joints to allow movement and flexibility between adjacent structural components.

### CONCLUSION

It is to be appreciated that the Detailed Description section, and not any other section, is intended to be used to interpret the claims. Other sections can set forth one or more but not all embodiments as contemplated by the inventors, and thus, are not intended to limit this disclosure or the appended claims in any way.

While this disclosure describes example embodiments for example fields and applications, it should be understood that the disclosure is not limited thereto. Other embodiments and modifications thereto are possible, and are within the scope and spirit of this disclosure. For example, and without limiting the generality of this paragraph, embodiments are not limited to the hardware and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different from those described herein.

References herein to “an embodiment,” “some embodiments,” “an example,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art to incorporate such feature, structure, or characteristic into other embodiment whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described embodiments, which are merely examples, but should be defined only in accordance with the following claims and their equivalents.

What is claimed is:

1. A bellows assembly comprising:
a first connecting portion configured to connect to a first component;
a second connecting portion configured to connect to a second component and distal from the first connecting portion; and
at least one convolution portion between the first connecting portion and the second connecting portion and configured to provide compliance such that the first connecting portion moves relative to the second connecting portion, the at least one convolution portion comprising:
a first end located toward the first connecting portion,
a second end spaced away from the first end, toward the second connecting portion,
a longitudinal axis extending from the first end to the second end and a lateral axis perpendicular to the longitudinal axis,
a first compliant portion extending outwardly away from the first end at a first angle relative to the lateral axis,
a second compliant portion,
a third compliant portion extending outwardly away from the second end at a second angle relative to the lateral axis,
the second compliant portion formed between and coupling to distal ends of the first and third compliant portions,
wherein the first angle and the second angle are between about 30 degrees to 80 degrees such that the first compliant portion and the second compliant portion form inward extending cone shapes.

2. The bellows assembly of claim 1, wherein the first angle and the second angle are equal such that the first compliant portion is parallel to the second compliant portion.

3. The bellows assembly of claim 1, wherein the first angle is different from the second angle such that the first compliant portion and the second compliant portion converge toward the first end and the second end.

4. The bellows assembly of claim 1, further comprising a starter portion that extends away from the second compliant portion along the longitudinal axis and is configured to provide a starting point for additively manufacturing the at least one convolution portion.

5. The bellows assembly of claim 1, wherein the first connecting portion is integral with the first component and the second connecting portion is integral with the second component, such that the first component, the first connecting portion, the second connecting portion, and the second component are a single piece structure.

6. The bellows assembly of claim 5, wherein the single piece structure is metal.

7. The bellows assembly of claim 1, wherein the first connecting portion and the second connecting portion move relative to one another in at least one of an axial movement perpendicular to the longitudinal axis, compression or extension along the longitudinal axis, and a gimballing tilting angle relative to the longitudinal axis.

8. The bellows assembly of claim 1, wherein the at least one convolution portion comprises at least four convolution portions.

9. The bellows assembly of claim 8, wherein the second compliant portion is located below the first end and the second end along the longitudinal axis.

10. The bellows assembly of claim 1, wherein the at least one convolution portion has a wall thickness of about 0.5 millimeters.

11. A bellows assembly comprising:
a first connecting portion;
a second connecting portion; and
at least one convolution portion formed between the first connecting portion and the second connecting portion and configured to provide compliance such that the first connecting portion moves relative to the second connecting portion, the at least one convolution comprising:
a first end,
a second end,
a longitudinal axis extending from the first end to the second end and a lateral axis perpendicular to the longitudinal axis,
a first compliant portion extending outwardly away from the first end at a first angle relative to the lateral axis,
a first tube portion extending away from the first compliant portion end,
a second tube portion radially spaced apart from the first tube portion,
a second compliant portion formed between and coupling the first and second tube portions,
a third tube portion radially spaced apart from the second tube portion and extending away from the second end approximately parallel to the longitudinal axis, and
a third compliant portion formed between and coupling the second and third tube portions.

12. The bellows assembly of claim 11, wherein the first angle is between about 30 degrees to 80 degrees such that the first compliant portion forms inward extending cone.

13. The bellows assembly of claim 11, wherein at least two of the first, second, and third tube portions are axially aligned along the longitudinal axis.

14. The bellows assembly of claim 11, wherein the first tube portion and the second tube portion are radially spaced apart by a first distance, and the second tube portion and the third tube portion are radially spaced apart by a second distance,
wherein the first distance is equal to the second distance.

15. The bellows assembly of claim 11, wherein the at least one convolution portion is at least four convolution portions.

16. The bellows assembly of claim 11, wherein the at least one convolution portion has a wall thickness of about 0.5 millimeters.

17. The bellows assembly of claim 11, wherein the at least one convolution further comprises:
a fourth tube portion radially spaced apart from the third tube portion,
a fourth compliant portion formed between and coupling the fourth tube portion to the second end and third tube portion,
a fifth tube portion radially spaced apart from the fourth tube portion and extending away from a third end,
a fifth compliant portion formed between and coupling the fourth and fifth tube portions.

18. A bellows comprising:
a first connecting portion at a first end of the bellows;
a second connecting portion at a second end of the bellows opposite the first end along a longitudinal axis of the bellows; and
a plurality of convolutions located between the first connecting portion and the second connection portion, the plurality of convolutions comprising:
compliant portions having an angled shape; and
compliant portions having a substantially arcuate shape, wherein the compliant portions having the substantially arcuate shape connect the compliant portions having the angled shape.

19. The bellows of claim 18, wherein the angled shape comprises an inward extending cone shape.

20. The bellows of claim 18, wherein the compliant portions having the angled shape comprise first compliant portions extending outwardly at a first angle relative to a lateral axis of the bellows, wherein the first angle is between about 10 degrees to 90 degrees.

21. The bellows of claim 20, wherein the first angle is between about 15 degrees to 45 degrees.

22. The bellows of claim 18, wherein the compliant portions having a substantially arcuate shape comprise second compliant portions.

23. The bellows of claim 22, wherein the second compliant portions comprise a fillet radius of about 0.5 mm.

24. The bellows of claim 18, wherein the compliant portions having the angled shape comprise third compliant portions extending outwardly at a second angle relative to the lateral axis of the bellows, wherein the second angle is between about 30 degrees to 45 degrees.

25. The bellows of claim 24, wherein the first compliant portions form inward extending cone shapes.

26. The bellows of claim 18, wherein the substantially arcuate shape comprises a smooth radius.

27. The bellows of claim 18, wherein the substantially arcuate shape comprises a compound radii curve.

28. A bellows comprising:
a first connecting portion at a first end of the bellows;
a second connecting portion at a second end of the bellows opposite the first end along a longitudinal axis of the bellows; and
a plurality of convolutions located between the first connecting portion and the second connection portion, the plurality of convolutions comprising:
compliant portions extending outwardly at a first angle between 15 degrees to 45 degrees relative to a lateral axis of the bellows; and
compliant portions extending outwardly at a second angle between 30 degrees to 45 degrees relative to the lateral axis of the bellows.

29. The bellows of claim 28, wherein the first angle is substantially narrower than the second angle.

30. The bellows of claim 28, wherein the first angle and the second angle are substantially equal.
